(19) United States
(12) Patent Application Publication
(10) Pub. No.: US 2009/0012842 A1
(43) Pub. Date: Jan. 8, 2009

(54) Methods and Systems of Automatic Ontology Population

(75) Inventors: Balaji S. Srinivasan, Palo Alto, CA (US); Rion L. Snow, San Francisco, CA (US)

Correspondence Address: WILSON SONSINI GOODRICH & ROSATI, 650 PAGE MILL ROAD, PALO ALTO, CA, 94304-1050, US

(73) Assignee: Counsyl, Inc., a Delaware Corporation, Palo Alto, CA (US)

(21) Appl. No.: 12/110,199

(22) Filed: Apr. 25, 2008

Related U.S. Application Data
(60) Provisional application No. 60/914,012, filed on Apr. 25, 2007.
(60) Provisional application No. 60/983,122, filed on Oct. 26, 2007.

(51) Int. Cl. G06Q 10/00; G06F 17/27; G06F 15/18; G06F 17/30; G06T 11/20; G06N 5/02; G06F 7/06

(52) U.S. Cl. 705/10; 704/9; 706/12; 706/47; 707/5; 707/102; 345/440; 707/E17.017; 707/E17.108

(57) ABSTRACT

Methods and systems for creating a knowledge graph that relates terms in a corpus of literature in the form of an assertion and provides a probability of the veracity of the assertion are disclosed herein. Various aspects of the invention are directed to and/or involve knowledge graphs and structured digital abstracts (SDAs) offering a machine readable representation of statements in a corpus of literature. Various methods and systems of the invention can automatically extract, structure, and visualize the statements. Such graphs and abstracts can be useful for a variety of applications including, but not necessarily limited to, semantic-based search tools for search of electronic medical records, specific content verticals (e.g. newswire, finance, history) and general internet searches.

### CROSS-REFERENCE

This application claims the benefit of U.S. Provisional Application No. 60/914,012, filed Apr. 25, 2007, and U.S. Provisional Application No. 60/983,122, filed Oct. 26, 2007, which applications are incorporated herein by reference in their entirety.

### BACKGROUND OF THE INVENTION

Integrating facts across many papers, finding papers with specific facts, and combining factual searches with searches by date, author, priority, or journal can be difficult. For example, a researcher who searches for papers on Parkinson's disease or aging is quickly overwhelmed with tens of thousands of papers, each with dozens of highly technical facts.

It can be difficult to reduce this information overload because searches typically are term driven and rarely include searching capability in more semantically natural ways. Aside from corpuses of literature in scientific, medical and business fields, it also is difficult to search the World Wide Web with semantic ease. It would thus be desirable to develop a machine-readable summary of a document or set of documents which permits semantic search and is also easily human-readable and writable.

Ontologies have become increasingly popular ways of formally organizing information. For example the Gene Ontology includes hierarchical relationships between biomolecules. Typically such ontologies are curated by individuals. Such methods are slow, difficult to scale-up and difficult to transfer to terms in corpuses in different fields.

Thus, an algorithm to automatically generate a machine-readable summary from unstructured text would open up a number of applications in the broad area of semantically informed search and manipulation of text. If this summary took the form of automatically learned ontological relations between terms, it would be nothing less than a tool to automatically learn the Semantic Web from unstructured text one of the major outstanding problems in information retrieval.

### SUMMARY OF THE INVENTION

In one aspect this invention provides method for generating a knowledge graph from a corpus of literature wherein the corpus has multiple documents, comprising: a. dividing documents from the corpus into sentences; b. parsing each sentence into entries wherein an entry comprises (i) a pair of terms and (ii) a linguistic dependency path describing a directional relation between the terms; c. creating a path-counts matrix from the parsed sentence entries comprising rows and columns wherein a row represents a pair of terms, a column represents a linguistic dependency path, and a cell represents the number of times in the corpus that the terms are connected by the path in a sentence; d. creating a knowledge graph comprising a plurality of statements, wherein each statement is obtained from a portion of the corpus, each statement comprising at least four elements wherein two elements are terms, one element is a directional relation that connects the two terms to form an assertion, and one element is an estimated probability that the assertion is true or false, wherein at least two statements share one term in common and one term not in common and at least one statement comprises an assertion that is not a hypernym/hyponym assertion; wherein the knowledge graph is created by: i. creating a training data set by assigning to a subset of term pairs probabilities of the truth of a directional relation for the pair; ii. using entries in the path-counts matrix and the training data set to produce rules for determining the probability related to the truth of a relation; and iii. assigning probabilities of the truth of the relation for pairs of terms of the knowledge graph using the rules, thereby creating the knowledge graph; and e. storing the knowledge graph on a computer readable medium. In one embodiment the method further comprises the step of creating a link from the knowledge graph to at least one sentence from which the probabilities were derived. In another embodiment the training data set is modifiable by a user.

In another aspect this invention provides a knowledge graph on a computer readable medium derived from a corpus of literature comprising a plurality of statements, wherein each statement is derived from a portion of the corpus, each statement comprising at least four elements wherein; a. two elements are terms; b. one element is a directional relation that connects the two terms to form an assertion; and c. one element is an estimated probability that the assertion is true or false; wherein at least two statements share one term in common and one term not in common and at least one statement comprises an assertion that is not a hypernym/hyponym assertion. In one embodiment the assertion contains an ontological relationship. In another embodiment each statement comprises at least five elements wherein one element is a back-trace object that provides a link to the portion of the corpus that supports the veracity of the assertion. In another embodiment the probability element of some statements is automatically generated from a corpus of data. In another embodiment the probability element of most assertions in the graph is automatically generated from a corpus of data. In another embodiment the graph is a resource description framework. In another embodiment the framework is a probabilistic RDF. In another embodiment herein the probability element is derived from a path-counts matrix from the corpus of literature wherein a column represents a linguistic dependency path, a row represents a pair of terms, and an entry represents the number of times the pair of terms is connected by the path in a sentence. In another embodiment the path-counts matrix is from parsed sentences of the corpus of literature. In another embodiment the entry of the path-counts matrix represents a boolean vector of the number. In another embodiment the probability is calculated from the boolean vector by logistic regression.

In another aspect this invention provides a method of searching a corpus of literature comprising obtaining the link from the back-trace object of a knowledge graph on a computer readable medium derived from a corpus of literature comprising a plurality of statements, wherein each statement is derived from a portion of the corpus, each statement comprising at least five elements wherein; a. two elements are terms; b. one element is a directional relation that connects the two terms to form an assertion; and c. one element is an estimated probability that the assertion is true or false; wherein at least two statements share one term in common and one term not in common and at least one statement comprises an assertion that is not a hypernym/hyponym assertion and e. one element is a back-trace object that provides a link to the portion of the corpus that supports the veracity of the assertion. In one embodiment the method further comprises displaying the portion of the corpus from which the assertion was obtained. In another embodiment the ontological relationship is part of an ontology.

In another aspect this invention provides an automatically produced structural digital abstract of a document comprising a machine readable abstract comprising a plurality of statements wherein a statement comprises at least four elements wherein; a. two elements are terms; b. one element is a directional relation that connects the two terms to form an assertion; and c. one element is an estimated probability that the assertion is true or false. In one embodiment the probability element is generated by applying rules determined using a path-counts matrix produced from parsed sentence entries from a corpus of literature, wherein a column in the path-counts matrix represents a linguistic dependency path, a row represents a pair of terms, and an entry represents the number of times in the corpus the terms are connected by the path in a sentence. In another embodiment the assertions further comprise a link to the portion of the corpus from which the assertion was derived.

In another aspect this invention provides a method of semantically searching biomedical literature comprising: a. providing a search string, wherein the string is at least one of a term, a relation, and an assertion of two terms with a directional relation linking the terms; b. comparing the search string with a knowledge graph produced from a corpus of literature which is stored on a computer readable medium comprising a plurality of statements, wherein each statement is obtained from sentences within the corpus, each statement comprising at least four elements wherein; i. two elements are terms; ii. one element is a directional relation that connects the two terms to form an assertion; one element is an estimated probability that the assertion is true or false; and iii. one element is a back-trace object that provides a link to the portion of the corpus from which the assertion was obtained; c. ranking the statements obtained from the back-trace object that are most closely related to the search assertion; and d. displaying a representation of a subset of the statements that are closely related to the search assertion. In one embodiment the method further comprises displaying a sentence from the corpus from which the statement was obtained using the back-trace object. In another embodiment the method further comprises displaying a reference from the corpus from which the statement was obtained using the back-trace object. In another embodiment the ranking is determined by at least one of the criteria selected from the group consisting of: the extent to which the statements match the search assertion, the impact factor of the reference from which the statements were derived, the number of citations to the papers from which the statements were derived, the number of citations to the authors of each paper, the number of citations involving topics which the paper covers, the time at which these papers were published, and the extent to which a given statement is central to a given topic. In another embodiment the knowledge graph is a structured digital abstract. In another embodiment the knowledge graph is a resource description framework. In another embodiment the framework is a probabilistic RDF. In another embodiment the portion of a sentence from which the statement was obtained is highlighted. In another embodiment the method further comprises entering search terms comprises issuing SQL or SPARQL queries.

In another aspect this invention provides a computer implemented method of searching the internet comprising: a. methodically searching documents on web pages; b. extracting the content of the pages with a program that utilizes a path-counts matrix, pairs of terms, and corresponding relationship probabilities derived from a corpus of literature to extract pairs of terms and calculate probabilities for relations between the terms; and c. storing the extracted content of the pages in a computer readable format.

In another aspect this invention provides a computer program product that generates a knowledge graph comprising: a. code that divides documents from the corpus into sentences; b. code that parses each sentence into entries wherein an entry comprises (i) a pair of terms and (ii) a linguistic dependency path describing a directional relation between the terms; c. code that creates a path-counts matrix from the parsed sentence entries comprising rows and columns wherein a row represents a pair of terms, a column represents a linguistic dependency path, and a cell represents the number of times in the corpus that the terms are connected by the path in a sentence; d. code that creates a knowledge graph comprising a plurality of statements, wherein each statement is obtained from a portion of the corpus, each statement comprising at least four elements wherein two elements are terms, one element is a directional relation that connects the two terms to form an assertion, and one element is an estimated probability that the assertion is true or false, wherein the knowledge graph is created by: i. creating a training data set by assigning to a subset of term pairs probabilities of the truth of a directional relation for the pair; ii. using entries in the path-counts matrix and the training data set to produce rules for determining the probability related to the truth of a relation; and iii. assigning probabilities of the truth of the relation for pairs of terms of the knowledge graph using the rules, thereby creating the knowledge graph.

In another aspect this invention provides a computer program product that generates a structured digital abstract comprising: a. code that divides a document into sentences, wherein the document belongs to or is to be added to a corpus of literature; b. code that parses each sentence into entries wherein an entry comprises (i) a pair of terms and (ii) a linguistic dependency path describing a directional relation between the terms; c. code that creates a path-counts matrix from the parsed sentence entries comprising rows and columns wherein a row represents a pair of terms, a column represents a linguistic dependency path, and a cell represents the number of times in the corpus that the terms are connected by the path in a sentence; and d. code that creates a knowledge graph comprising a plurality of statements, wherein each statement is obtained from a portion of the corpus, each statement comprising at least four elements wherein two elements are terms, one element is a directional relation that connects the two terms to form an assertion, and one element is an estimated probability that the assertion is true or false, wherein the knowledge graph is related to the document, thereby creating a structured digital abstract.

In another aspect this invention provides a business method comprising; a. entering into a contract with an owner of a corpus of literature to produce an ontological graph from their corpus; b. producing a knowledge graph by creating a path-counts matrix from the parsed sentence entries from the corpus of literature wherein a column represents an linguistic dependency path, the rows represent a pair of terms, and the entries represent the number of times the terms are connected by the path in a sentence, wherein revenue is derived from the use of the knowledge graph that was generated from the owner's corpus of literature. In one embodiment the revenue is derived by selling ad space on a web page that allows search of the knowledge graph. In another embodiment the revenue is derived by selling access to the database. In another aspect this invention provides a graph representing assertions derived from a body of literature, wherein the assertions are represented in statements, wherein each of the statements includes two terms and relation, the relation term connecting the two terms, thereby forming an assertion, the graph comprising: a. a plurality of assertions, each representing the two terms and a relation, wherein the relation is a directional relation; and b. at least one estimated probability that the directional relation of at least one of the assertions is true or false.

In another aspect this invention provides a method for determining a confidence level of an assertion present in a body of literature wherein the assertion represents a relationship between two terms, the method comprising: a. generating relational data to represent a relationship between each of the terms and the assertion; and b. using the relational data to estimate a confidence level for the assertion. In one embodiment the relational data is represented in a path-counts matrix.

In another aspect this invention provides a method for determining a veracity level of an assertion representing a relationship between two terms using a body of literature, the method comprising: a. from the body of literature, automatically accessing assertions where each assertion represents an relation that connects the two terms; b. for the automatically accessed statements, defining a numerically-based relationship with the assertion; c. using the numerically-based relationship to generate estimated probability data as a confidence level for the assertion.

In another aspect this invention provides a computer implemented method comprising: a. generating relational data from a corpus of literature for a pair of terms in a corpus of literature; and b. correlating the relational data with a confidence level for an assertion, wherein the assertion comprises the terms and a directional relation that connects the terms. In one embodiment the method further comprises displaying the confidence level and the assertion on a user interface.

In another embodiment the method further comprises providing the confidence level and assertion to a user conducting a computer based search.

In another aspect this invention provides a method comprising: a. executing computer code that generates training data comprising a plurality of elements, each element comprising (i) an assertion comprising a pair of terms from a corpus and a directional relation between the terms, (ii) a confidence level that the assertion is true or false for the terms and (iii) relational data between the terms derived from the corpus; and b. executing computer code that generates a rule that classifies the confidence that the assertion is true or false for a pair of terms from the corpus.

In another aspect this invention provides a system comprising: a. a database comprising a corpus of literature in machine readable form; and b. a computer comprising an algorithm for determining a confidence level of an assertion present in a body of literature wherein the assertion represents a relationship between two terms, wherein the algorithm; (i) generates relational data to represent a relationship between each of the terms and the assertion; and (ii) uses the relational data to estimate a confidence level for the assertion.

### BRIEF DESCRIPTION OF THE DRAWINGS

The following detailed description that sets forth illustrative embodiments, in which various principles in accordance with aspects of the invention are utilized, and includes the accompanying drawings of which:

FIG. 1 demonstrates an example of a graphic representing an ontology. A typical ontology is manually curated and populated. After a curator has verified a relationship between a pair of terms, he can enter the statement (for example, dog is a animal) into the ontology. As new relations are verified, they are added to the ontology to complete the ontology.

FIG. 2 demonstrates an “is_a”” relationship, as most ontologies rely on is a relationships as the core relationship or semantic relation. However, ontologies can also have other standard relationships, such as “develops_from” and “is_a_part_of”.

FIG. 3 shows a sentence can be represented as a dependency tree. For example, the sentence in FIG. 3 can be represented by the dependency tree in FIG. 3 wherein the nodes of the tree are nouns and the verbs and prepositions can be used to determine the relations between the nodes.

FIG. 4 describes an overview of the invention. The input is a focused content corpus and a training set of term pairs satisfying relations (obtained from manual population and/or one or more ontologies).

FIG. 5 demonstrates an example knowledge graph of the invention. In the example embodiment, the graph comprises two terms and one directional relation that form an assertion. The assertion can then be assigned a probability that the assertion is true. Also shown in FIG. 5, an evidence code can be assigned to the assertion that indicates how the assertion was generated, for example, automatically by a method of the invention, or manually by a user that updated the graph.

FIG. 6 illustrates a pattern can be extracted from phrases such as “PDK1 and other kinases”, from which can be taken the assertion (PDK1) (is_a) (kinase).

FIG. 7 illustrates an example method of developing a program code to populate an ontology. For example, a pseudocode can be written that requires prespecification of regular expressions to find example of a given relation.

FIG. 8 describes an alternate way of representing a pattern, namely as a directed path in a dependency parse tree.

FIG. 9 shows manually generated examples of a relation that provides a training set for pattern discovery. For example, it has been entered by a curator or user that a (female germ line stem cell) (is_a) (germ line stem cell), and therefore, the probability of truth of the relation is set at 1 (100%) as shown in FIG. 10.

FIG. 10 demonstrates two terms related by an is_a relationship that is known to be true, therefore the probability of truth of the relation equals 1.

FIG. 11 illustrates the use of negative training data.

FIG. 12 demonstrates a relation between unlabeled pairs can be predicted from the training set.

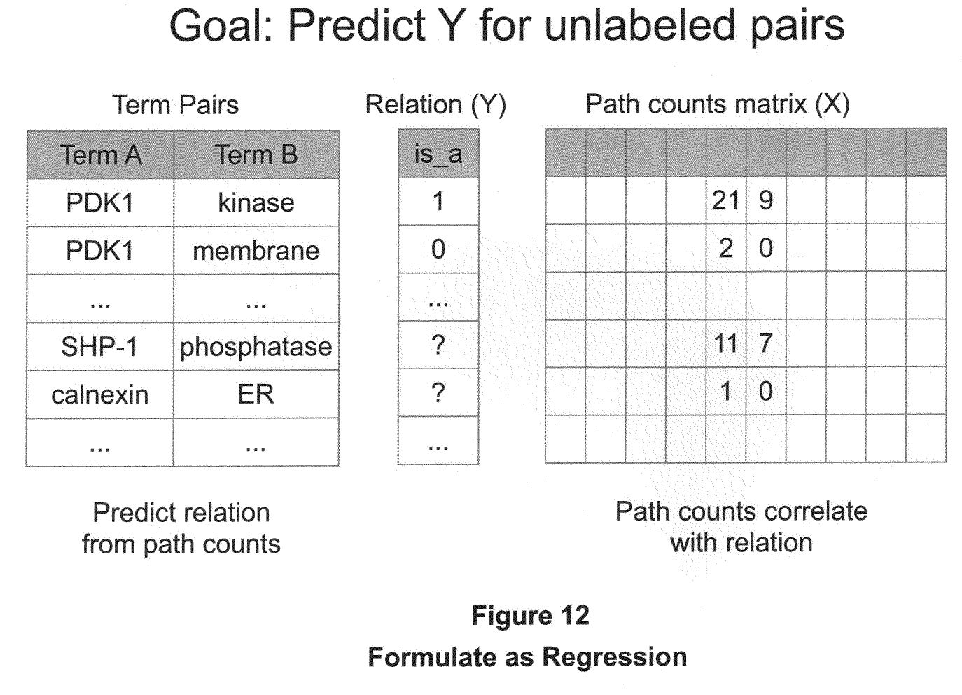

FIG. 13 illustrates using sparse logistic regression to compare the path counts matrix to a training set so the assertion (SHP-1) (is a) (phosphatase) can be evaluated to determine a probability of the truth of the assertion.

FIG. 14 depicts an embodiment, given training data, wherein any type of relation can be predicted between an unlabeled pair of terms.

FIG. 15 demonstrates a large regression problem, such as a method of the invention, wherein a table for use with regression is significantly larger than the main memory of a computer system. For example, there may be more than tens of millions of columns in the path counts matrix and more than tens of millions of rows corresponding to a pair of terms.

FIG. 16 shows how after the problem is FIG. 15 has been split into subsets, sparse logistic regression can be carried out on each subset to determine the regression coefficients of the path count columns of the path counts matrix for each subset.

FIG. 17 depicts the overall regression coefficient vector that can be used to evaluate over each row in the table to obtain the probability that an unlabeled term pair satisfies the relationship.

FIG. 18 illustrates example psuedocode for carrying out a sparse logistic regression problem of the invention.

FIG. 19 demonstrates the output of a regression method used to infer assertions. The regression produces a sparse regression coefficient matrix. For example, the number of nonzero entries of a given row of a large regression problem is significantly less than the overall number of columns in the problem (for example, the positive rows are curated assertions and the columns are all the linguistic dependency paths in a corpus).

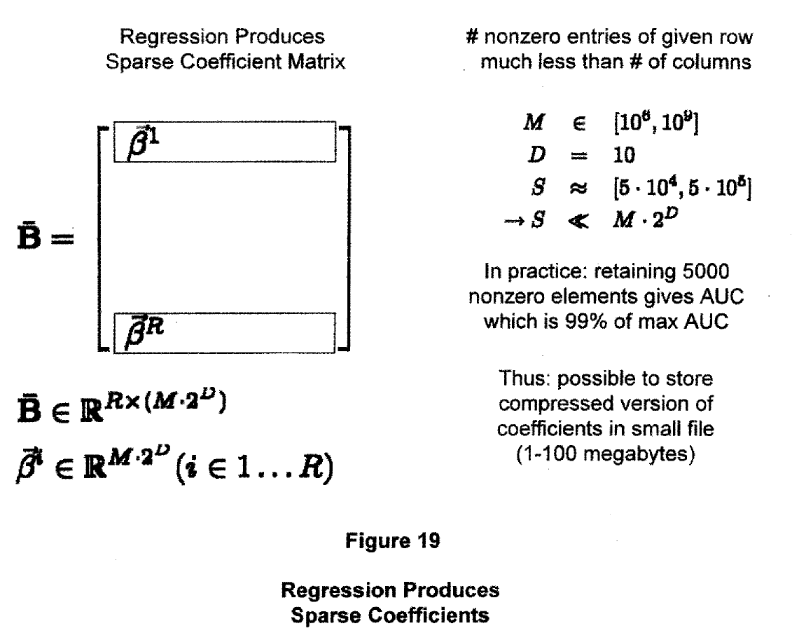

FIG. 20 demonstrates how to evaluate the extent to which the algorithm has learned a given relation. The relation extraction algorithm can be viewed as a binary classifier, and a standard metric of binary classifier performance is the AUC, the area under the receiver operator characteristic or ROC curve.

FIG. 21 illustrates an example of two different representations of a knowledge graph of the invention, one as a table and one as a graph.

FIG. 22 illustrates an example of a method of using a back-trace object. For example, an assertion of the knowledge can be associated with a back-trace object that links the assertion back to particular portions of the corpus from which the assertion was automatically generated.

FIG. 23 illustrates an expansion of a method of automatically generating a structured digital abstract. A table can be created that summarizes all the assertions in an individual article or portion of a corpus using a method of the invention.

FIG. 24 demonstrates that the automatically generated SDAs can then be subsequently modified by humans or other programs. Different modifications change the evidence codes associated with each assertion in an SDA. In the figure, an author reviews the automatically generated SDA and changes the probability of the statement that “Bax has_function induction” to 1.0. As an author made this change, the evidence code for the assertion is updated from “Inferred by Electronic Annotation (IEA)” to “Traceable Author Statement (TAS)”. A full list of evidence codes is available at www.geneontology.org/GO.evidence.shtm. In addition to the reflected change in evidence codes, a timestamped history is kept of which users changed which rows, which IP they changed the rows from, and so on.

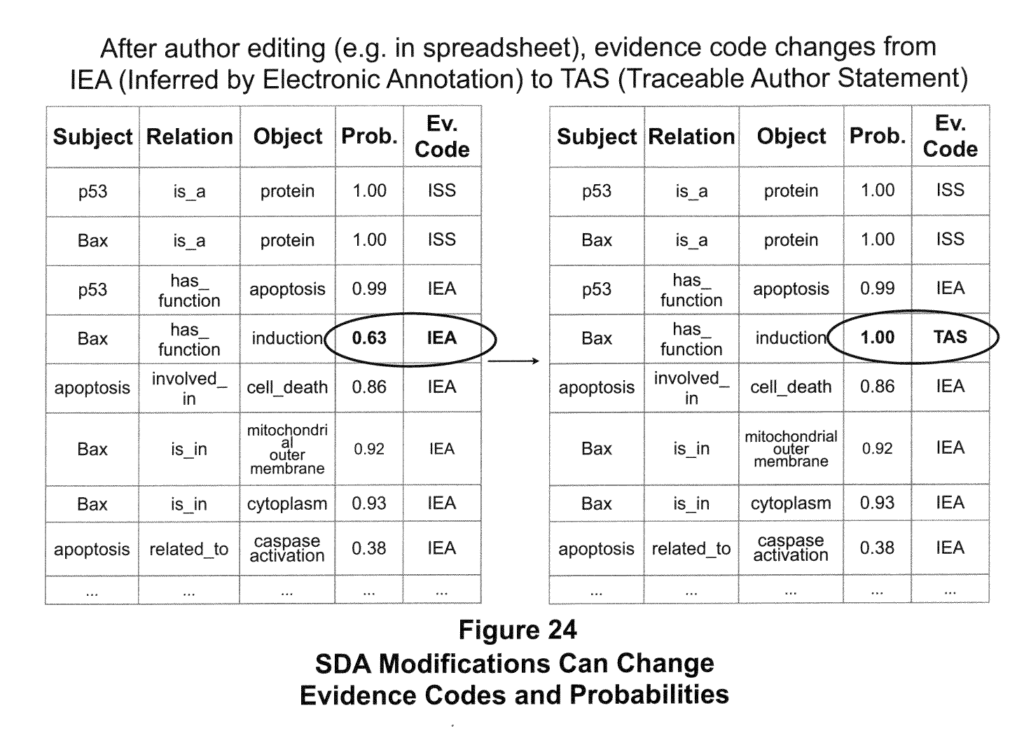

FIG. 25 illustrates how backfilled SDAs can be integrated with the current scientific literature publishing process. A database of published papers is subject to an offline SDA calculation (using the large-scale random undersampling algorithm). The resulting SDAs for each article are then deployed to the web. Authors, readers, and curators can modify the SDAs for previously published papers, changing the evidence codes and recording history as described above.

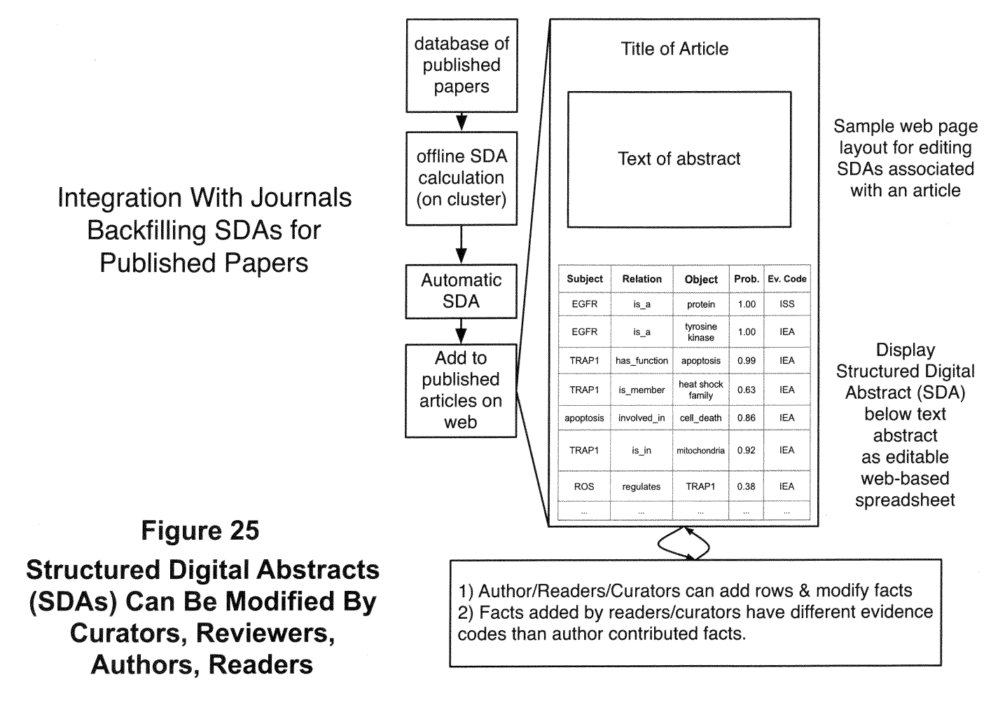

FIG. 26 illustrates how new manuscripts can be integrated with the publishing process. A new manuscript can be summarized in an SDA using an online SDA calculation (with the SDA from_text function described in FIG. 33), for example as implemented in a word processor plugin (FIG. 35). The author can manually correct or edit the SDA and text and iterate until he is satisfied with the SDA. The SDA and manuscript can then be submitted for review and the manuscript and SDA can be revised and edited in response to reviewers and editors. The manuscript is then published and can include the SDA or the SDA can again be generated by a method of the invention for populating an ontology. The SDA can then be edited again, if necessary, after publication for curation.

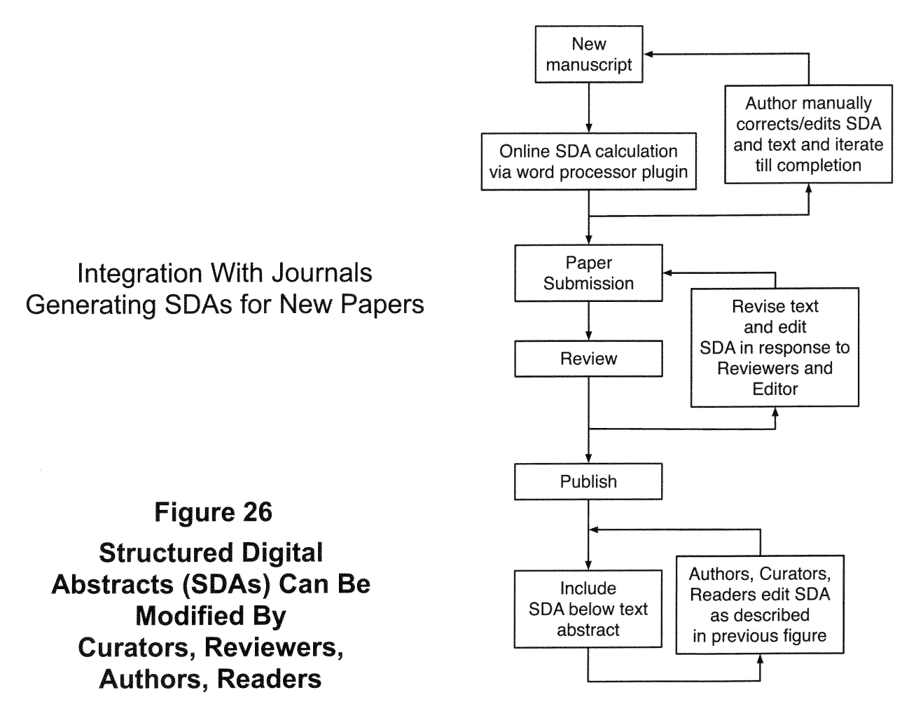

FIG. 27 depicts a search of the knowledge graph for a single subject: MAPK, with wildcards for the relation and object. The search turns up relationships with “kinase activity,” “transmembrane,” and “apoptosis” with associated probabilities.

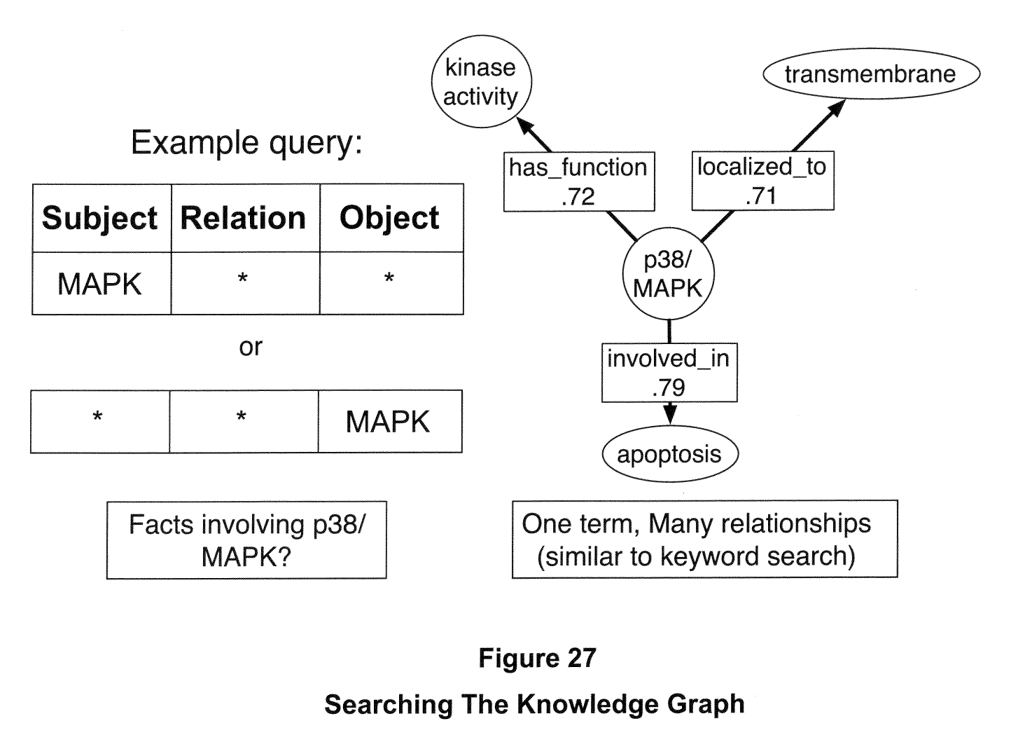

FIG. 28 depicts a search of the knowledge graph for term pairs having the relationship: “is_chemical_subclass”. This search turns up many term pairs that satisfy this relation with high probability.

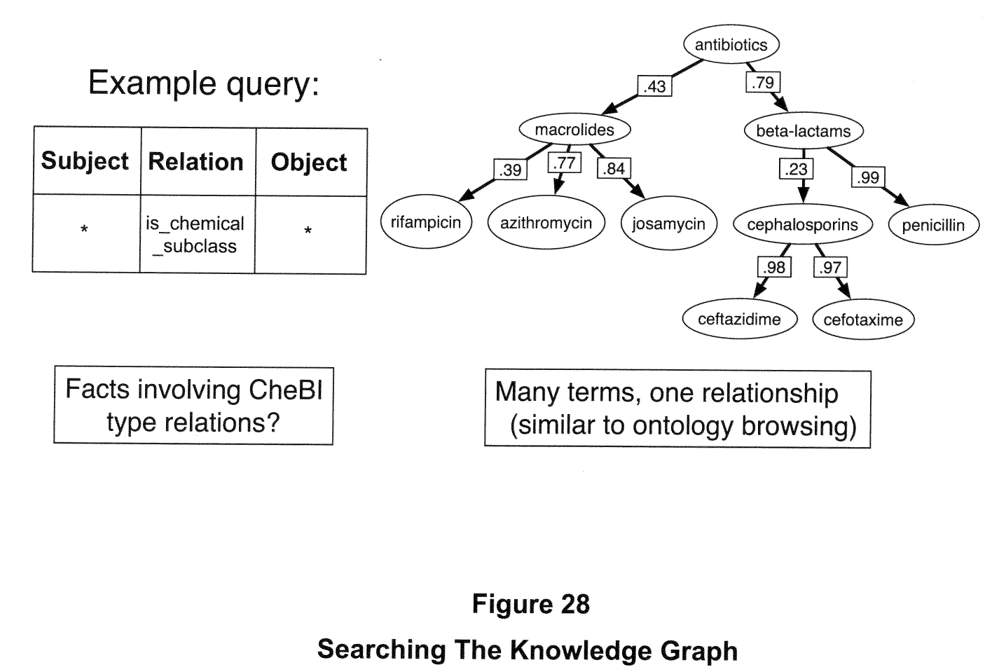

FIG. 29 depicts a search of the knowledge graph for proteins in the endoplasmic reticulum. Results satisfy two search criteria: “is a protein” and “is_in endoplasmic reticulum”. Note that this kind of query is difficult with keyword based search.

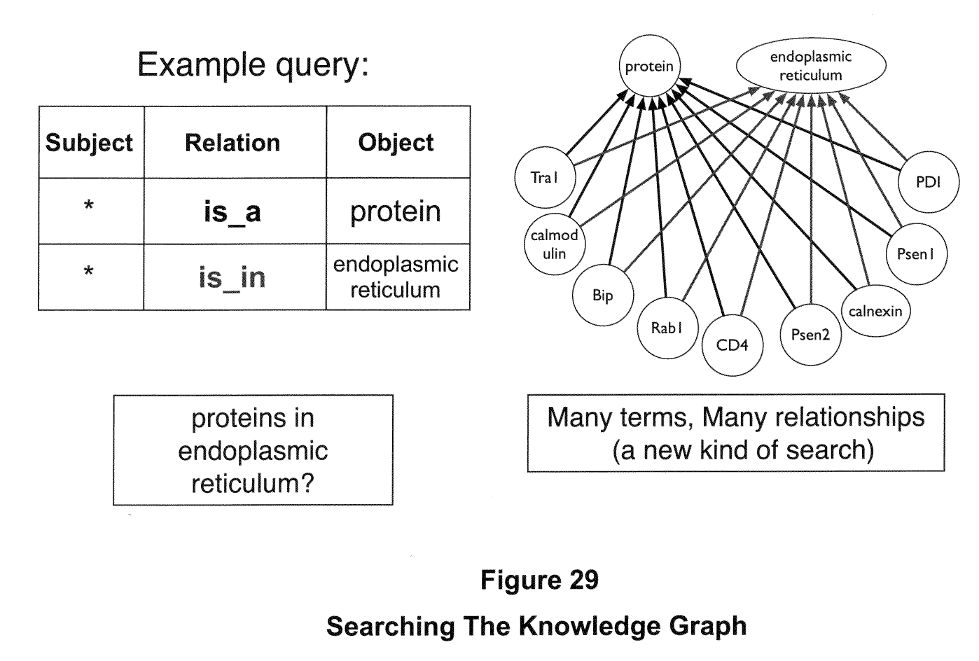

FIG. 30 depicts a search of the knowledge graph for a conceptually simple search that is difficult to do using typically available search engines. In this case esters located in the endoplasmic reticulum are difficult to search because articles which categorize molecules as esters are generally from a different content domain than articles which discuss compound localization. However, using the knowledge map of this invention, the chemical subclass relationship is already defined and can be used to search both relationships. This demonstrates the power of simultaneously learning many rare relationships.

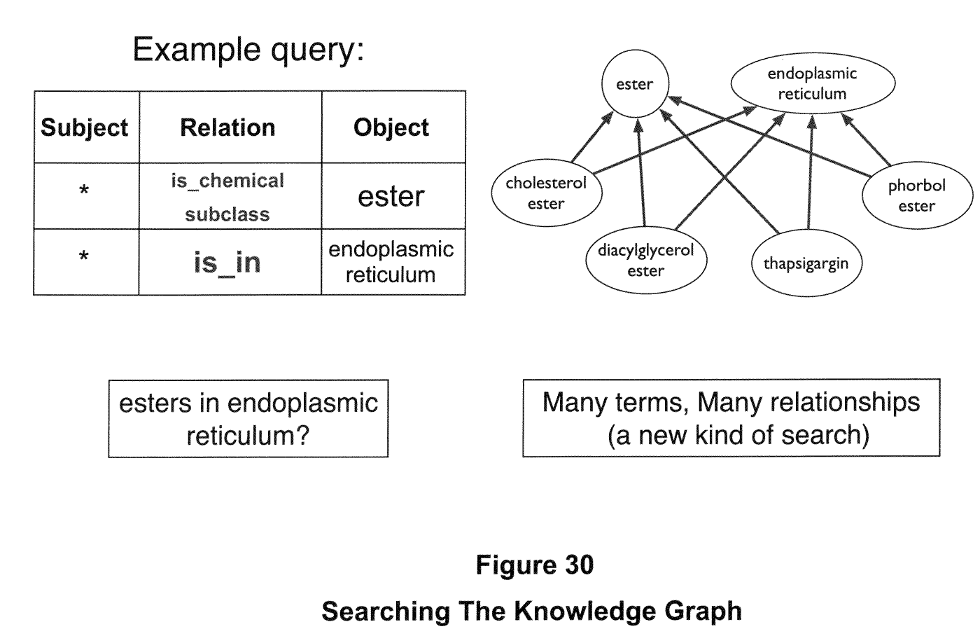

FIG. 31 depicts a search which joins the knowledge graph with other tables. This search is for the first article that showed that calorie restriction increases life span. The knowledge graph is searched for the statement, “(calorie restriction) (regulates) (life span).” The search uses back-traces to identify relevant articles which provide evidence for this fact. The articles are in turn linked to metadata indicating year of publication.

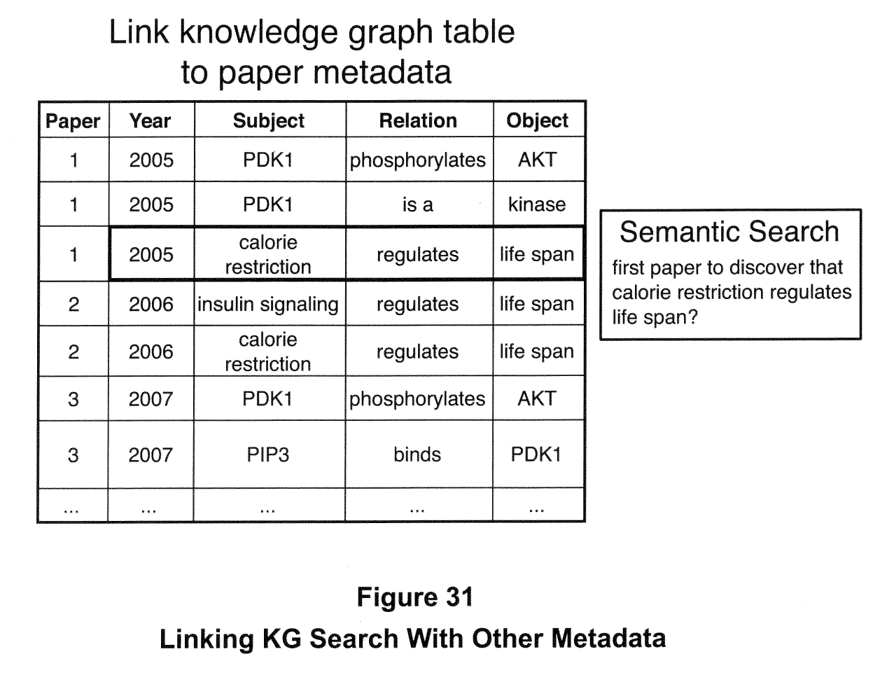

FIG. 32 depicts another example of using metadata. In this case, the metadata used is the network of references, also know as the citation map. The query is the identification of prior articles referenced by a given paper that support propositions asserted in the original paper. The structured digital abstract of the original article gives the assertions supported in that article. An SDA for each referenced article is reviewed to determine whether it contains an assertion that also is in the SDA for the original article. This establishes the priority of facts in the corpus and gives a more granular view of the corpus.

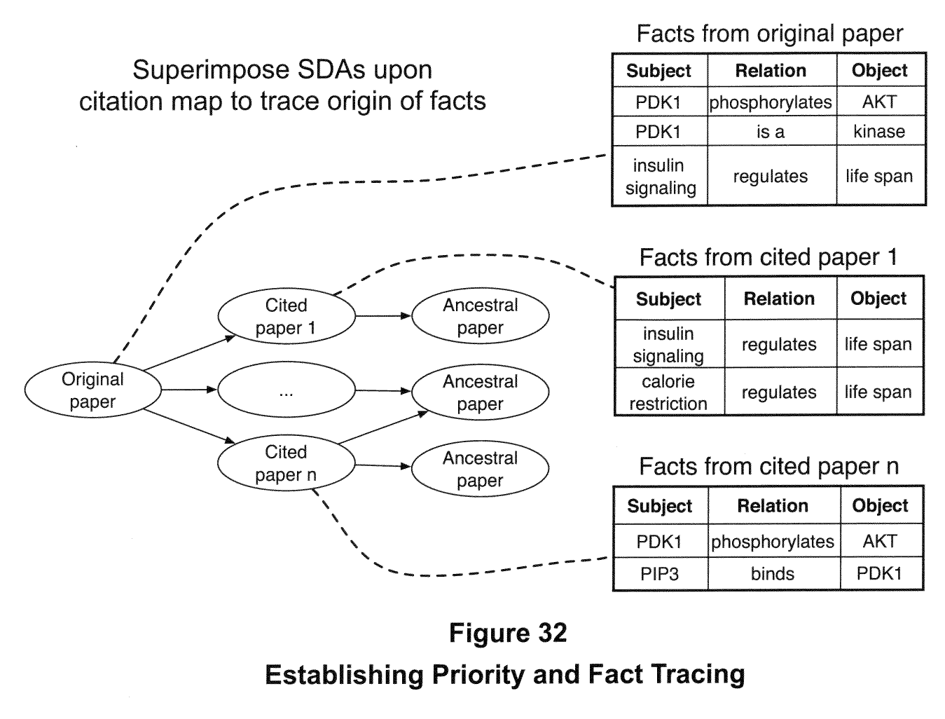

FIG. 33 depicts the implementation of a function SDA_from_text( ) which computes an SDA from a given string of text. Importantly, this function can be included in a library, embedded in an application, or distributed over the web. The reason is because while the data that generates the regression models is quite large (it could be in the terabyte size), the regression coefficients themselves are sparse and hence small (see FIG. 19), on the order of a few megabytes after compression. Moreover, given a large enough corpus in a focused content area, regression coefficients will be relatively stable for the key relations in that area and can be considered fixed when given new articles in the content area outside the original corpus. This is because there are only so many ways to state a relationship in text, and linguistic change is not rapid enough to obsolesce coefficients trained on a large corpus. Hence a single up-front cost allows calculation of regression coefficients for a given focused content area. Once regression coefficients are obtained for a given focused content area, individuals can download the library containing the SDA_from_text( ) function and use it to create SDAs from any new article in that content area. The flow chart illustrates how this takes place. The text of the article is an argument to SDA_from_text( ). The text is parsed into dependency trees and a path counts matrix is generated. The regression model is applied using the path counts matrix and returns probable relations in the text, thereby creating the SDA.

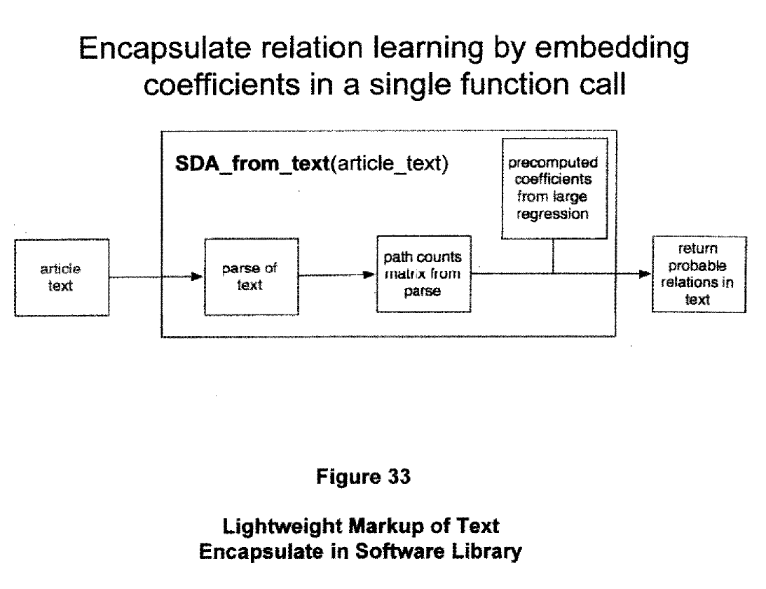

FIG. 34 depicts a means for using the SDA_from_text( ) function to convert unstructured web page text into an SDA. Extracting relations from free text in this way represents a means of automatically populating the Semantic Web without human intervention, a problem of considerable importance.

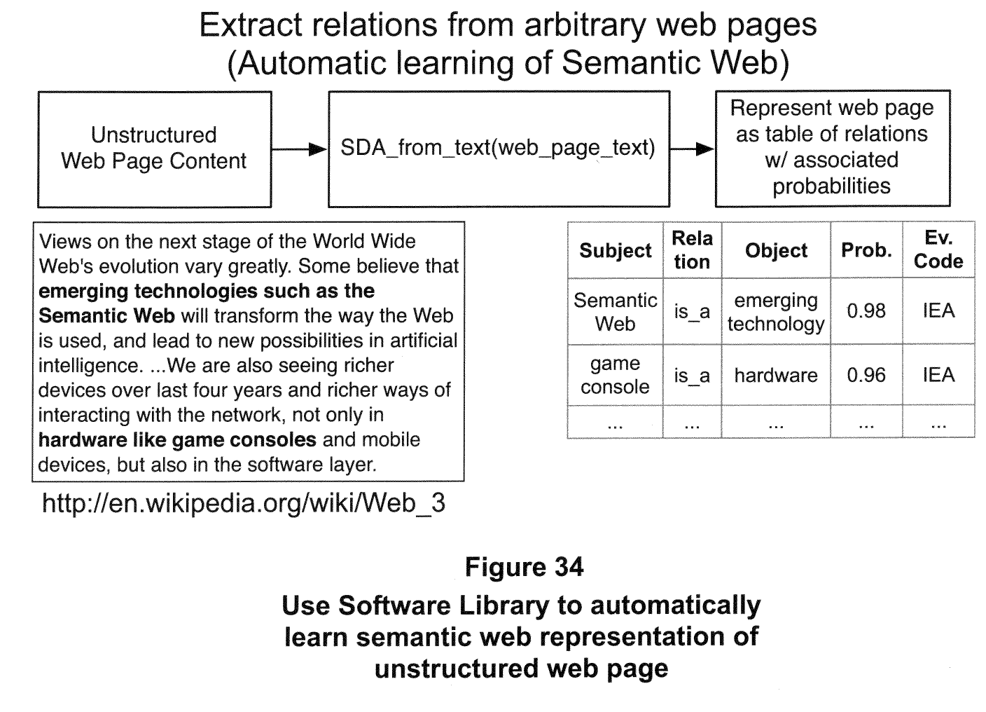

FIG. 35 depicts a “plug-in” application for use with a word processing program such as Microsoft Word or WordPerfect. The plug-in uses the SDA_from_text( ) function to creates an SDA from a draft document. The author can review the abstract and determine whether it includes statements that the author intends to convey in the article. If not, the author can amend the article to include sentences that cause the desired statement to appear in the abstract.

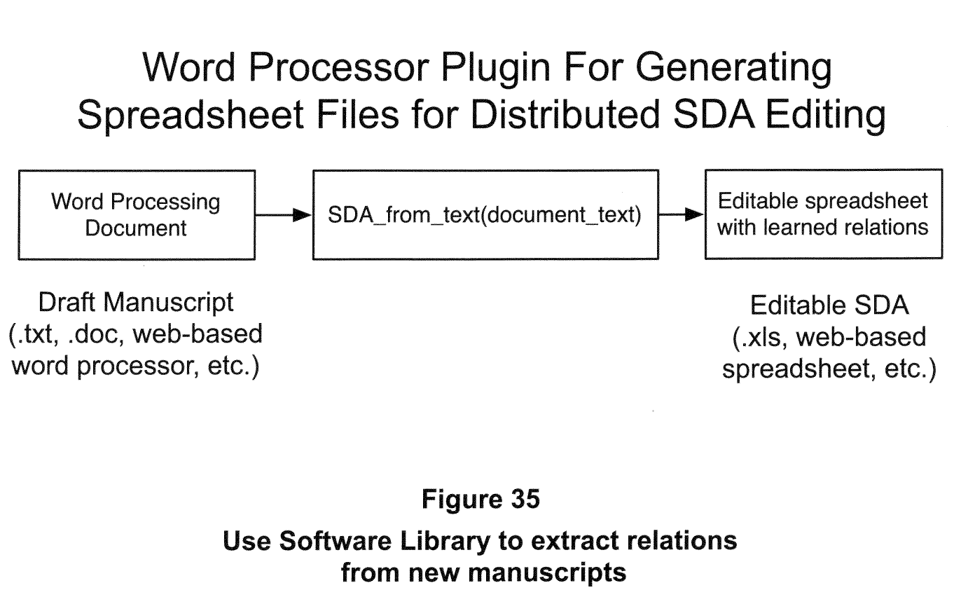

FIG. 36 depicts how a biological model can be updated using SDAs. The Figures shows a model that contains relationships between PIP3, PDK1 and AKT, as understood on May 31, 2007.

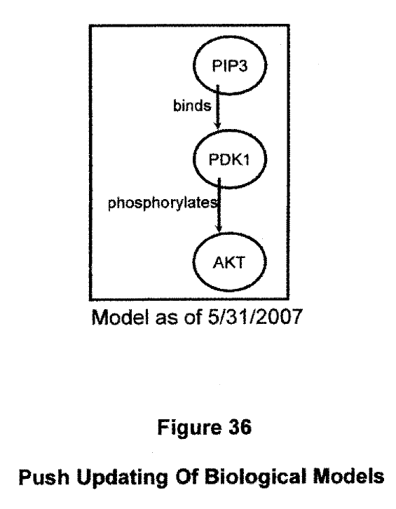

FIG. 37 depicts the addition of another relationship, between PI3K and PIP3 that is documented by a new SDA representing a new paper and abstracted on Jun. 1, 2007. Importantly this is a “push” update is done entirely without user intervention. The user does not need to pull relevant papers down to their system—instead the papers (and the key facts in those papers) are automatically identified and brought to their computer. This permits “reading without reading”, in that essentially the entire biomedical literature can be monitored for new papers relevant to the user.

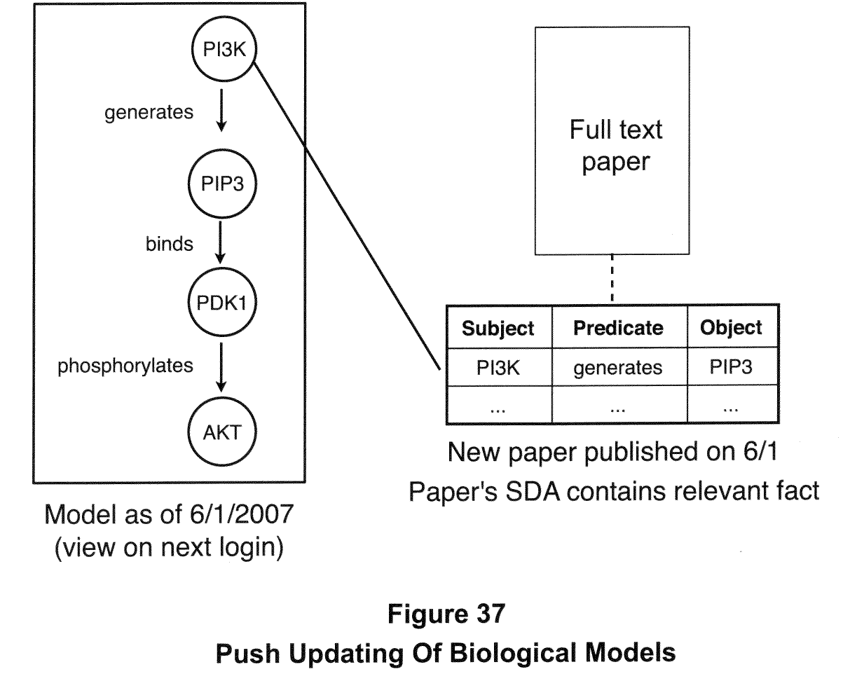

FIG. 38 depicts a sample user interface for performing a search of the knowledge graph. For a user facing application we can use less technical terms such as “fact” for an ontological assertion and “supporting evidence” for the backtraces for each assertion. The interface has fields from which the user can select two terms, the “subject” and “object” and a relationship through which they are connected. Sample searches, depicted here as nonsense latinate terms (lorem ipsum), provide sample queries to demonstrate search functionality. Such sample queries can include complex queries of the form described in FIG. 30.

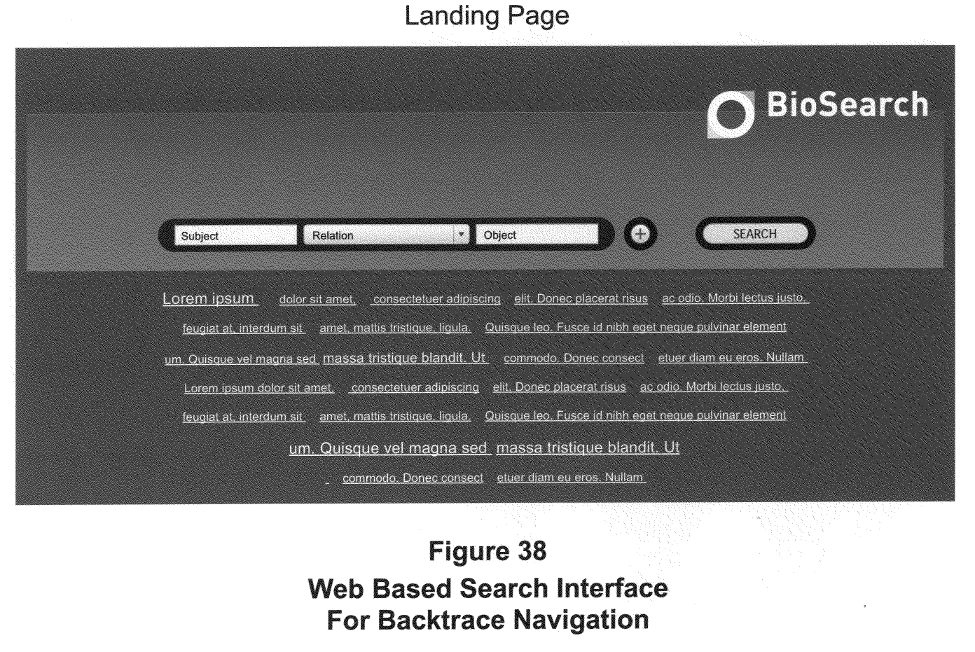

FIG. 39 depicts a sample user interface for performing a more complex search. In this case two related searches, either additive or exclusive, can be performed, for example as shown in FIGS. 17.03 and 17.04. In the “Facts” box, the search returns results that match the search criteria and that are ranked according to relevance. Selecting a fact in the Fact box refreshes content in the “Supporting Evidence” box, which includes articles identified using backtraces that relate to the fact selected. Each entry can contain rich information, including the article title, a summary, article descriptors such as author, journal and date, as well as links to view the abstract and related facts. Both facts and backtraced sentences can be ranked by a variety of criteria including the extent to which the facts match the search query, the impact factors of the references from which the facts were derived, the number of citations to the papers from which the facts were derived, the number of citations to the authors of each paper, the number of citations involving topics which the paper covers, the time at which these papers were published, and the extent to which a given statement is central to a given topic. Weighted averages or combinations of these criteria along with empirical usage statistics (e.g. from visitor logs and queries) can be used to further optimize retrieval.

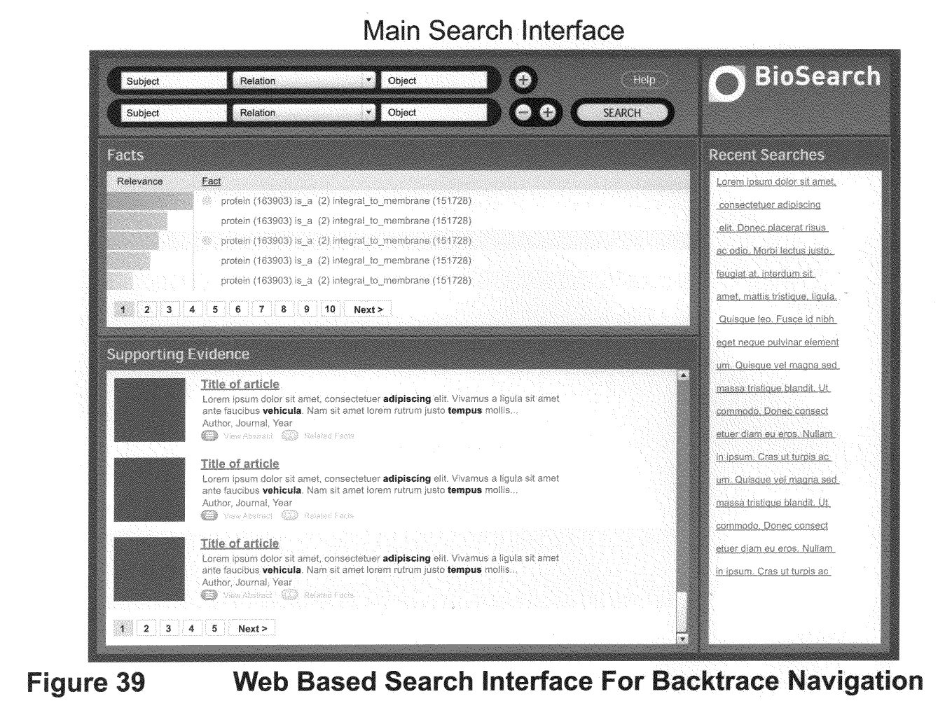

FIG. 40 depicts an abstract selected from the page presented above in lightbox format.

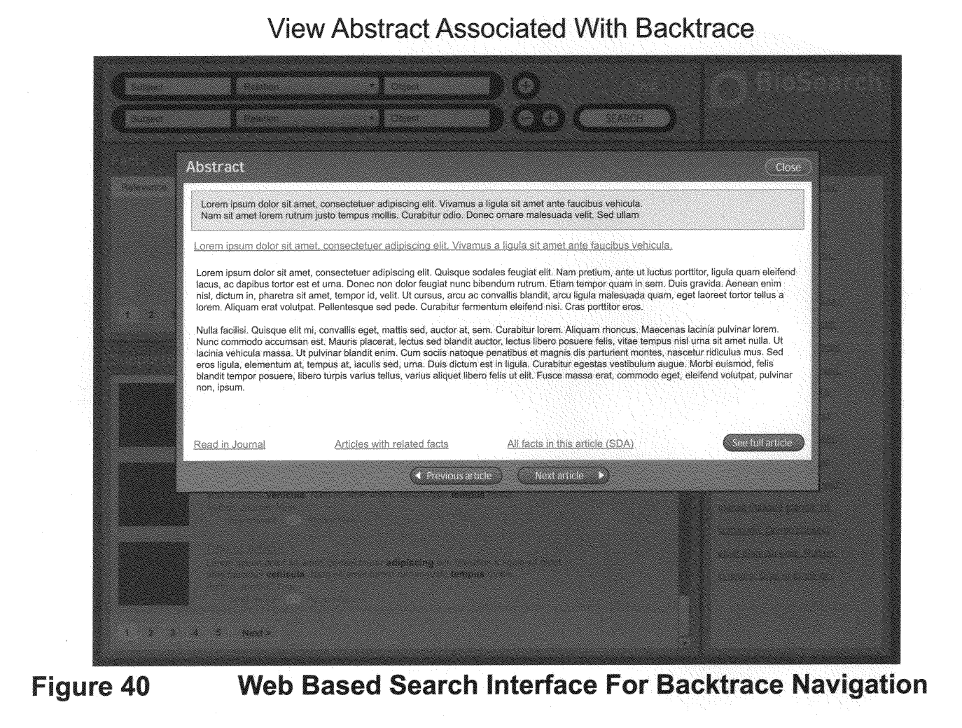

FIG. 41 depicts a magnified version of the search results for a rich object in this case one of the backtraced sentences that provide support for a given assertion. The result is formatted in such a way that it can easily be incorporated into a major search engine's results list.

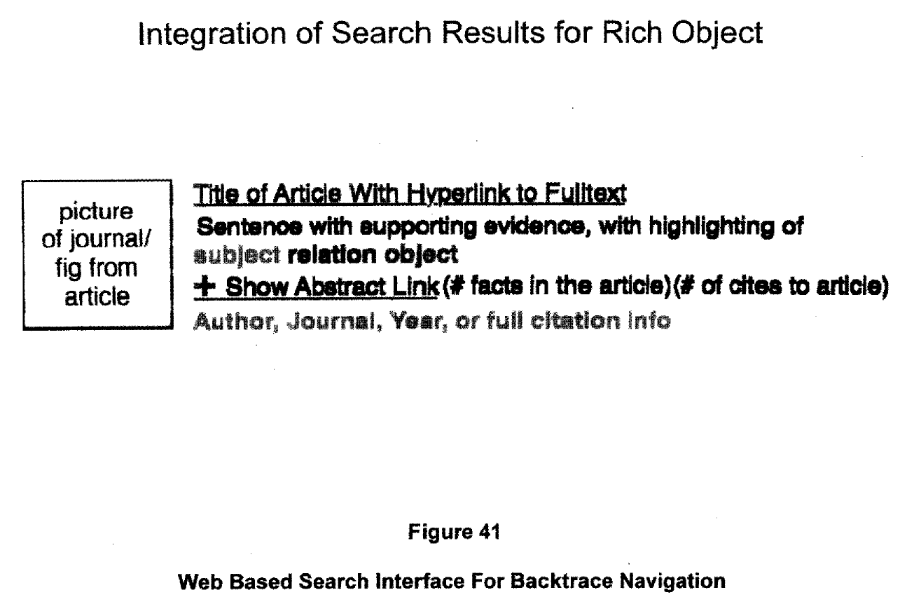

FIG. 42 depicts a magnified version of the abstract for the backtraced sentence. Note that several new options appear below the abstract, including a link to the journal site, a recommendation engine for articles with related facts, and a list of all facts in the article (i.e. the SDA).

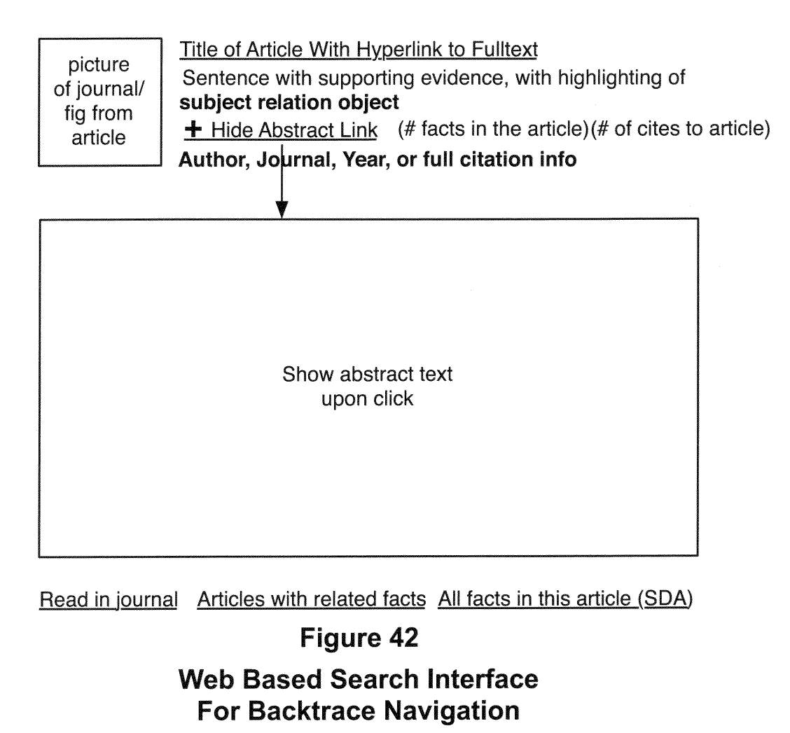

FIG. 43 depicts a method of expanding existing ontologies. In this case, a curator can use the knowledge graph to find new relationships and the evidence that supports them through back traces. The curator can decide whether to add the term to the existing ontology based on the produced evidence. Note also that while it is difficult to manage the hierarchical constraints associated with an ontology, it is comparatively easy to simply enumerate examples of term pairs that satisfy a given relationship. The “positive feedback loop” described above for learning relations from an arbitrary focused content area is also applicable for the ontology curator.

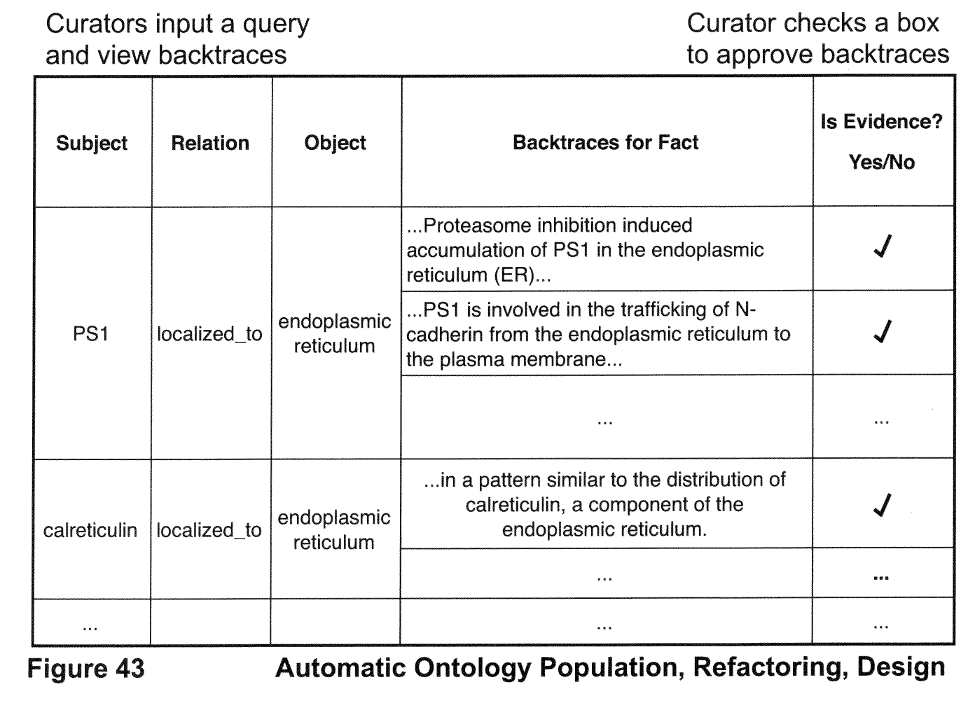

FIG. 44 depicts a method of improving the content of existing ontologies. Assertions in these ontologies are tested against the knowledge graph to determine the probability of the assertions. Assertions with very low probabilities can potentially be eliminated from the ontologies, as they have little explicit evidentiary support.

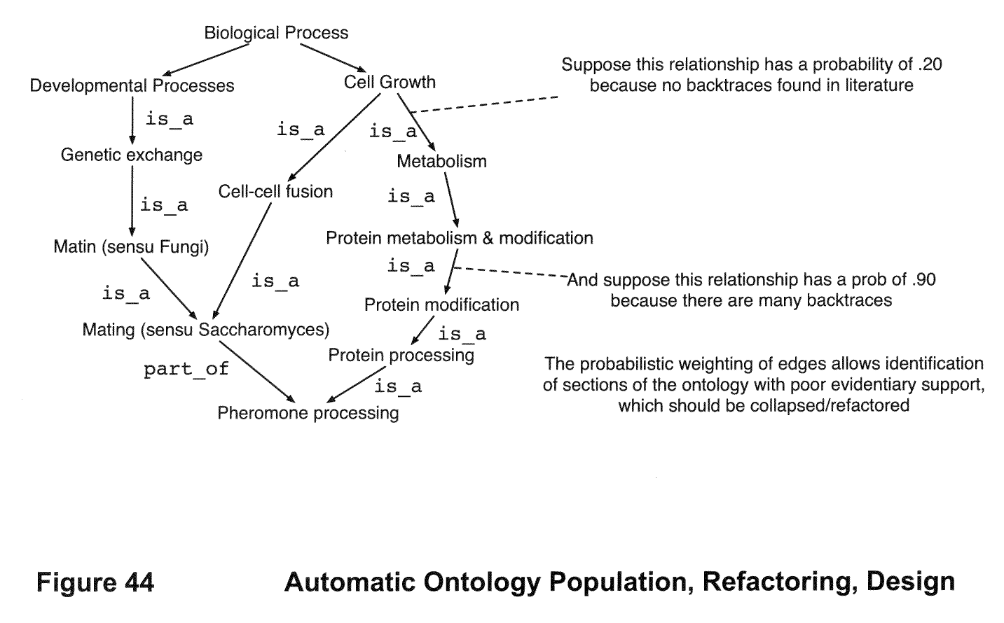

FIG. 45 depicts the generation of a knowledge graph for electronic medical records. In this case, the corpus can be any set of medical records including, e.g., digitized patient discharge summaries. The corpus is abstracted into sentences and parsed into dependency paths. The terms and relations can come from a medical ontology such as Unified Medical Language System (UMLS), MeSH, or the ICD ontologies (e.g., TCD-9 or ICD-10). The knowledge graph that emerges using the methods described herein can then be used to create SDAs of each medical record. Such records now can be searched in an organized way.

FIG. 46 depicts a type of search that can be carried out using the knowledge graph generated by the method of FIG. 45. For example, a physician can search for instances in which a particular drug Decadron is prescribed. The results of the search indicate the probability that the drug was prescribed for a particular condition. Because the knowledge graph includes back-traces to the source sentences and documents in the corpus, the physician can review in more detail the situations and conditions under which the drug was prescribed. The method is not, of course, limited to searching for drugs, but could include searches for diseases, patients belonging to defined classes, diagnoses, therapies and patient responses. Other kinds of data can be joined to the relations learned by the knowledge graph, including the hospital(s), resident(s), time(s), and ward(s) in which the discharge summary was modified. Such combinations of data are of epidemiological relevance (e.g. in determining outbreaks or adverse side effects).

FIG. 47 depicts the generation of a knowledge graph for business content. The corpus can be, for example, business news sources (newspapers, newswires, SEC filings, etc.). The terms and relations can be curated by a curator or can include known financial ontologies such as XBRL.

FIG. 48 depicts a sample search performed on a business database. Any business term can be searched, including people, companies, financial information, products, legal proceedings, etc. By linking the knowledge graph with back traces to the corpus, one can find articles related to the search query. In this case, the user searches for billionaires trained in mathematics.

### DETAILED DESCRIPTION OF THE INVENTION

### Introduction

This invention provides a method for creating a knowledge graph that relates terms in a corpus of literature in the form of an assertion and provides a probability of the veracity of the assertion. Importantly, the relationships included in the knowledge graph include not only hypernym/hyponym relationships (e.g., A is_a B. or A belongs to the set of B), but also other relationships that occur more rarely in the corpus, such as meronym/holonym relationships (e.g., A part_of B) and other arbitrary semantic relationships (e.g., A develops_from B; A successor_of B. A phosphorylates B, A acts_on B, or A acquires B). These rare relationships can be learned by using a training set large enough to provide a statistically significant number of instances in which the two terms are related in the corpus and performing random under-sampling followed by logistic regression with bootstrap averaging. The logistic regression function for any particular relationship can then be applied to any pair of terms in the corpus for which the veracity of the assertion is not known. The result is a map or table containing pairs of terms from the corpus and the probability of the truth of a number of different relationships between the terms.

In addition, each statement can include a back-trace to statements in the corpus, e.g., articles, that support the truth of the assertion. A knowledge map with this feature is useful as a search tool for searching the corpus for articles pertaining to the assertion. The relationships can be selected to include common semantic terms used in natural language, thus allowing a more natural semantic search of the corpus.

The rules learned for the various relationships can be applied to individual articles in the corpus. The result is a structured digital abstract that includes probable assertions for terms used in the article.

### Knowledge Graphs

Various aspects of the invention are directed to and/or involve knowledge graphs and structured digital abstracts (SDAs) offering a machine readable representation of statements in a corpus of literature. Here, a “corpus of literature” denotes any body of text composed of sentences or sentence fragments. Various methods can automatically extract, structure, and visualize the statements. Such graphs and abstracts can be useful for a variety of applications including, but not necessarily limited to, semantic-based search tools for literature such as the category of a type of scientific articles. A specific category involves assertions relating to biological models. While the invention need not necessarily be limited to scientific articles or biological models a discussion of various aspects of the invention may be appreciated through a discussion of various examples using this context. Further implementations involve identification of assertions, facts and personalized updates of biological models. Other examples of applications for the methods and systems of the invention include, but are not limited to, search of electronic medical records, specific content verticals (e.g. newswire, finance, history) and general internet search.

In an embodiment of the invention, a knowledge graph of a corpus of literature comprising a plurality of statements on a computer readable medium is disclosed, wherein each statement of the graph is obtained from a portion of the corpus, each statement comprising at least four elements. Of the at least four elements, two elements are terms, one element is a directional relation that connects the two terms to form an assertion, and one element is an estimated probability that the assertion is true or false.

In some embodiments, an assertion is two terms linked by a directional relation. In the context of this disclosure, a statement can represent an assertion and the estimated probability that the assertion is true or false. In an embodiment, at least two statements share one term in common and one term not in common. Each statement can also comprise at least five elements wherein one element is a back-trace object that provides a link to the portion of the corpus from which the assertion was obtained. In some embodiments the statements may contain other elements. In an embodiment providing a link to a sentence from which the assertion probability was ascertained, the back-trace object can provide access to many kinds of other metadata regarding the sentence.

In an embodiment, a knowledge graph is a structure used to model pairwise relations between objects or terms from a certain collection. A knowledge graph in this context can refer to a collection of terms or nodes and a collection of relations or edges that connect pairs of nodes. In an embodiment, a knowledge graph is represented graphically by drawing a dot for every term, and drawing an arc or line between two terms if they are connected by an edge or relation. If the graph is directed, the direction can be indicated by drawing an arrow. In some instances, the knowledge graph can be stored within a database that includes data representing a plurality of terms and relations between the terms. The database structure can be conceptually/visually represented as a graph of nodes with interconnections. Accordingly, the term knowledge graph can be used to denote terms and there relations.

In an embodiment, a knowledge graph is implemented as a data structure that can be represented as a graph. For example, the link structure of a website could be represented by a directed graph: the nodes are the web pages available at the website and a directed edge from page A to page B exists if and only if A contains a link to B. Graphs are ubiquitous in computer science, operations research, biology, and many other fields. In an embodiment of the invention, a knowledge graph can include a weight or probability that is assigned to each edge or relation of the graph.

A corpus of literature or corpus of data from which the knowledge graph in accordance with aspects of the invention is derived can be, for instance, a set of literature articles. In some embodiments the corpus of literature can be substantially all of the articles or publications in a database such as PubMed/Medline, SciSearch, JSTOR, ArXiv, etc. In some cases the corpus of literature can be the articles or publications of multiple databases. In some embodiments, the corpus of literature can be all of the articles or publications of a journal or set of journals. In some embodiments, the corpus of literature can be a set of articles or publications in an area of science or medicine such as biomedical literature or medical literature. In some embodiments, the corpus of literature can be the text portion (e.g. discharge summaries) of a set of electronic medical records. In some embodiments, the corpus of literature can be the collection of a large number of articles in a defined content area, such as the set of all articles in the Wall Street Journal, Financial Times, and Economist, or the collection of all documents in a presidential library. The assignment of probabilities to an assertion can be useful linguistically. Probabilities of assertions can be useful in examining relationships between terms or objects in a number of different fields including, but not limited to, biology, mathematics, computer science, engineering, chemistry, physics, journalism, and law. For example, biologically, the concepts of phosphorylation and activation are not entirely synonymous, as phosphorylation is but one way in which activation can happen; many other post-translational modifications (such as farnesylation) can cause activation. Linguistically, stating that “A phosphorylates B” is very straightforward, while it is more indirect to say that “the activator of B is A”. Thus when a scientist intends to say “A phosphorylates B”, he is more likely to write it directly rather that indirectly. In both cases, the occurrence of the phrase “X phosphorylates Y” can be stronger evidence than phrase “the activator of Y is X” for the fact (X) (phosphorylates) (Y).

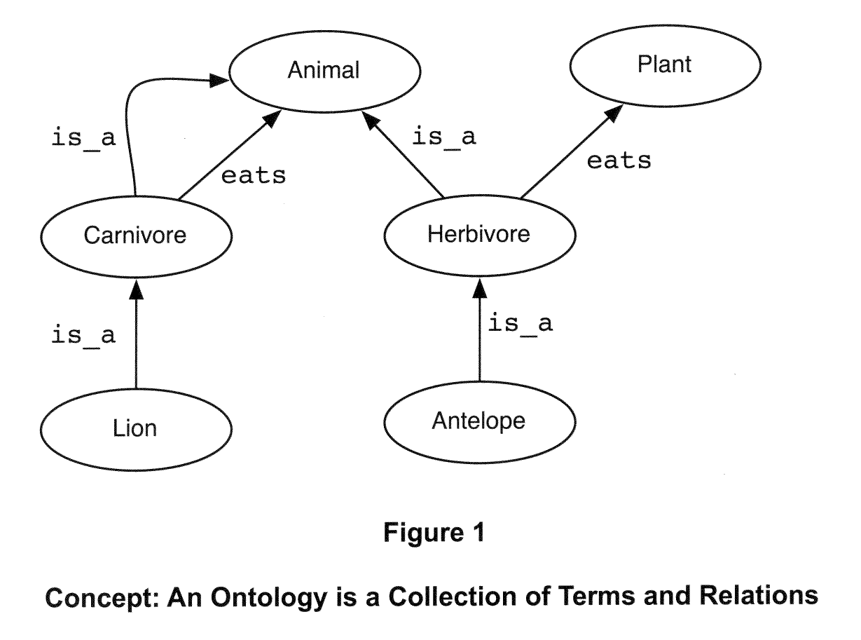

The assertion can be an ontological relationship and be part of an ontology or network. An ontology typically comprises a controlled vocabulary of terms and a set of directional relationships which hold between some pairs of terms. Ontologies are often generated manually by curators. FIG. 1 demonstrates an example of a graphic representing an ontology. For the purposes of this disclosure, an ontology is a collection of terms and relations between the terms. For example, a lion is a carnivore and a lion is an animal that cats an animal. As demonstrated in FIG. 1 a graphic representation can be created of the ontology. An ontology can be a group of terms that are related, for example a biological ontology, a gene ontology, a collection of text from a news wire or webpages. A typical ontology is manually curated and populated. After a curator has verified a relationship between a pair of terms, he can enter the statement (for example, dog is a animal) into the ontology. As new relations are verified, they are added to the ontology to complete the ontology.

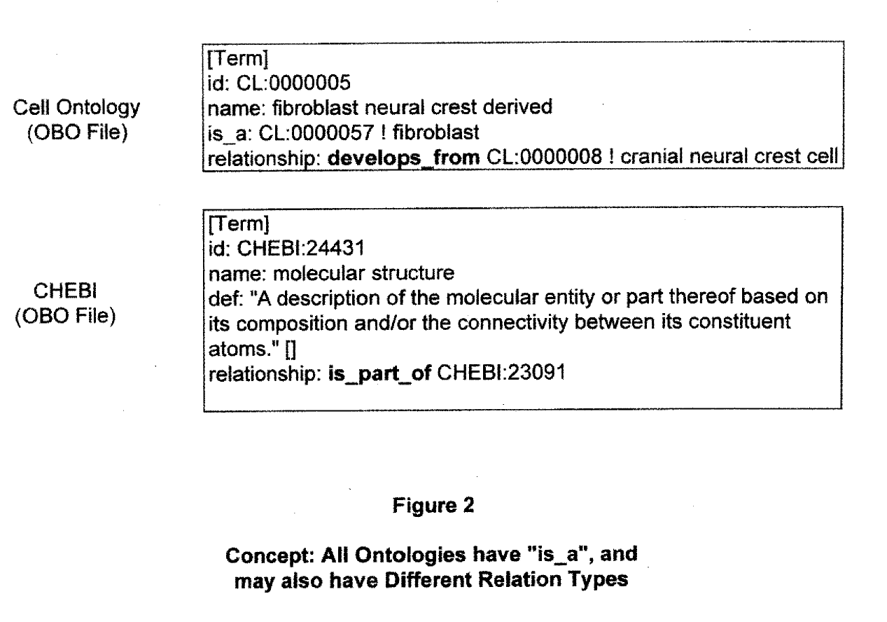

An ontology can have a plurality of relations. FIG. 2 demonstrates an “is_a” relationship, as most ontologies rely on is_a relationships as the core relationship or semantic relation However, ontologies can also have other standard relationships, such as “develops_from” and “is_a_part_of”. In another embodiment, the relationships are defined by a person.

The invention described herein can reduce a barrier of curation, making it possible for a curator to generate about 100 to about 1000 or more pairs of terms which satisfy a given relation to utilize as training data for a method in accordance with aspects of the invention. Examples of public ontologies include the OBO collection (Open Biomedical Ontologies), GO (Gene Ontology), and the UMLS (Unified Medical Language System) OBO subsumes GO and contains many other ontologies. UMLS is a set of medical ontologies while OBO is a set of research-focused ontologies. There are also several other non biomedical ontologies such as WordNet (an ontology for general text) and FOAF (an ontology for interpersonal relationships). These other ontologies can be used as training data if the extraction algorithm is applied to non biomedical text.

In an embodiment, the methods and systems described herein illustrate automatic ontology population. Many ontologies have evidence codes to support the assertions in the ontology. For example, if the assertion was entered by a curator, the ontology associates an evidence code with the assertion that indicates the assertion was curated by a human. Other examples of evidence codes include evidence codes for assertions in an ontology are that are electronically inferred from other relations of the two terms. In an embodiment of the invention, an assertion can be generated by a method or computer system and automatically entered into the ontology without manual curation. An evidence code can be given to the assertion in the ontology indicating the assertion was inferred or generated by automatic ontology population. In another embodiment, assertions that are used to automatically populate an ontology can be assigned a probability of being true. In an embodiment, the probability of the truth of an assertion can be used as an evidence code indicating automatic population. In another embodiment, a probability can affect the evidence code for the assertion.

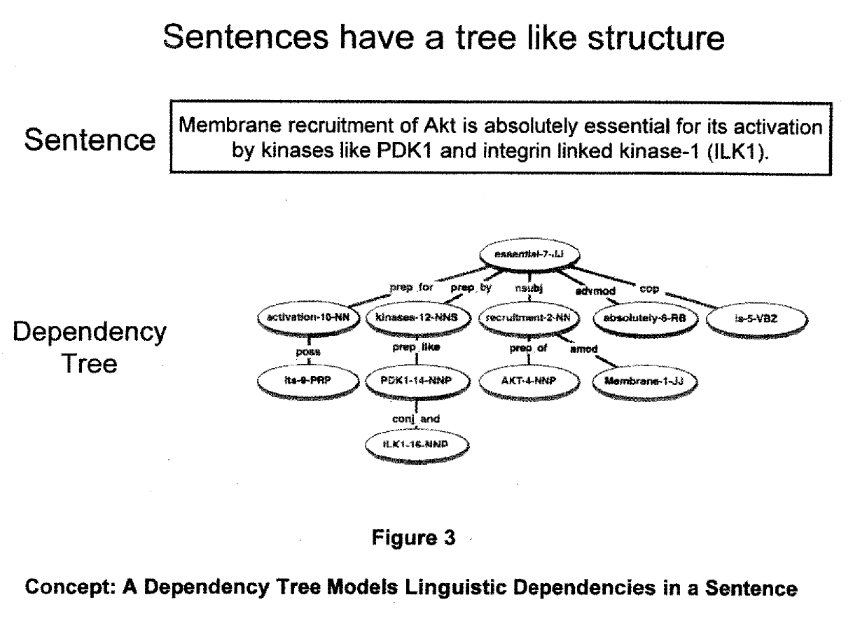

A sentence, paragraph, document, or corpus can be represented as a dependency tree. For example, the sentence in FIG. 3 can be represented by the dependency tree in FIG. 3 wherein the nodes of the tree are nouns and the verbs and prepositions can be used to determine the relations between the nodes. A dependency tree forces a structure on a sentence. In an embodiment, a dependency tree of a sentence can be formed by parsing the sentences into assertions.

Integrating facts across many papers, finding papers with specific facts, and combining factual searches with searches by date, author, priority, or journal can be difficult. For example, a researcher who searches for papers on Parkinson's disease or aging is quickly overwhelmed with tens of thousands of papers, each with dozens of highly technical facts. It would be desirable to develop a machine-readable summary of a document or set of documents which is also easily human-readable and writable, In particular, an algorithm to automatically generate a machine-readable summary from unstructured text would open up a number of applications in the broad area of semantically informed search and manipulation of text. If this summary took the form of automatically learned ontological relations between terms, it would be nothing less than a tool to automatically learn the Semantic Web from unstructured text, one of the major outstanding problems in information retrieval.

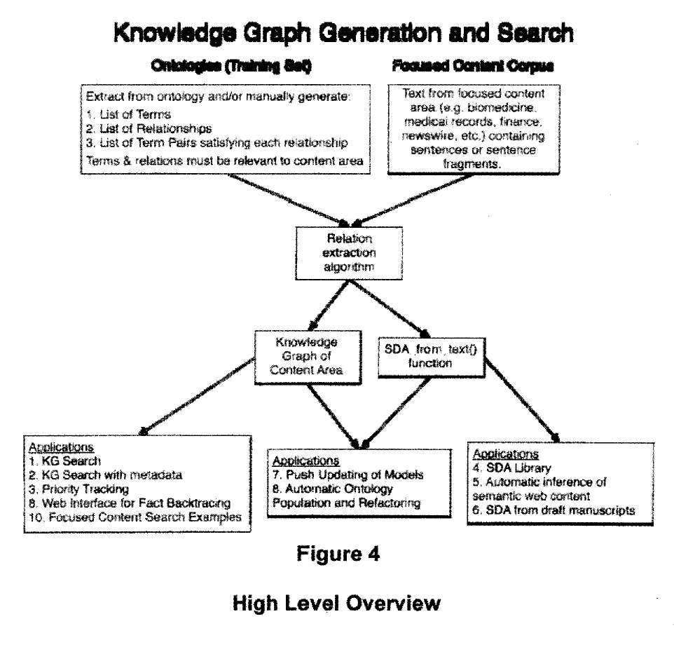

FIG. 4 describes an overview of the invention. The input is a focused content corpus and a training set of term pairs satisfying relations (obtained from manual population and/or one or more ontologies). This input is passed to the relation extraction algorithm, producing two useful outputs: 1) a collection of machine readable summaries for individual articles in the corpus and 2) a function for rapidly generating machine readable summaries of new articles in the content area. Individual article summaries are called SDAs for Structured Digital Abstracts, and the collection of summaries is called the Knowledge Graph of the content area. These two outputs enable a number of applications which will be described subsequently.

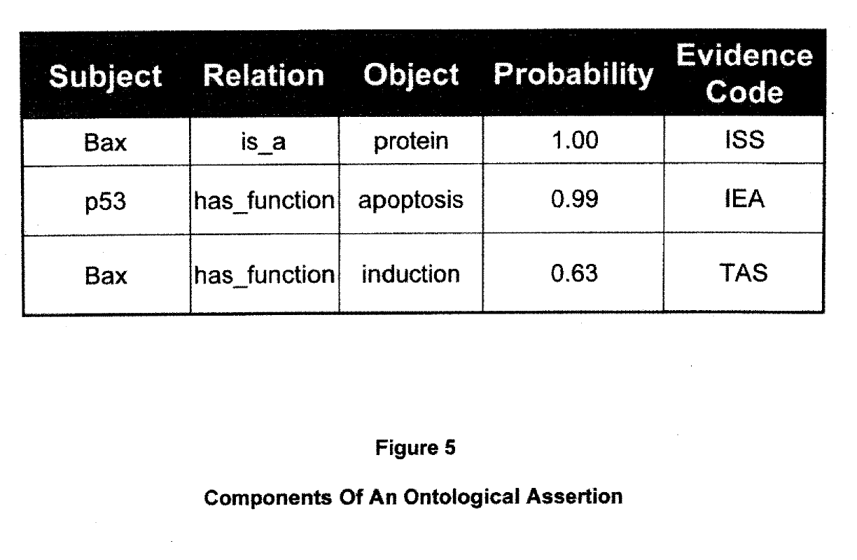

In a particular embodiment, a knowledge graph can be structured in resource description framework (RDF) format. In a further embodiment, the format is probabilistic RDF with evidence codes (shown in FIG. 5). An RDF is often a type of file format. RDF representation can be simpler and more powerful than standard XML, as it allows representation of general directional graphs rather than hierarchical graphs alone. Briefly, an RDF file is a table of triples. Each triple contains 3 unique identifiers known as URIs or Uniform Resource Identifiers. Frequently, URIs are URLs of the sort that you would type into your browser, but they can be any unique ID such as an Entrez Gene ID or a GO Term ID.

Commonly, each RDF file contains a set of facts about the URIs in the file. If every user utilizes the same URIs, facts can be generated in a distributed fashion and shared.

RDFs have proven generally useful for thinking about graphs, especially graphs that have many different kinds of links (for example, different relations or predicates). Unlike an XML file format, which can force a hierarchical or tree structure on a data set, an RDF can allow compact representation of general types of graphs. The knowledge graph can be a systematic notation of assertions. To represent assertions in a structured manner, the assertions can be represented as triples using the N3 notation for RDF. If inferred or learned automatically, these triples can have an associated probability relating to the truth of the assertion, or, if entered by a user, this probability can be manually assigned (for example, set to one for a fact).

In an embodiment a table with a triple of subject (A), object (B), and predicate (rel) can be used to form an assertion. For example, a table contains three examples of subject/object pairs which satisfy the “is_a” relationship. For example, the “is_a” relationship is directional in that (dog) (is a) (animal) but the reverse relationship (animal) (is_a) (dog) does not hold. Also in the example, the subject and object terms can be multi-word phrases in general in addition to single words.

A large corpus can then be searched for sentences or phrases in the corpus that exactly or approximately contain the subject and object terms as substrings. In an embodiment, matching can be done with either exact hash lookup or via approximate matching, such as with an open source variant of the Wu-Manber algorithm (for example, as implemented in agrep). It is often useful to group matches using a table of term synonyms; for example, the strings “RNA” and “ribonucleic acid” represent the same term. In an embodiment, the linguistic insight can be some of the sentences which contain the subject and object also contain textual patterns which imply the “is_a” relationship between the subject and object.

FIG. 5 demonstrates an example knowledge graph of the invention. In the example embodiment, the graph comprises two terms and one directional relation that form an assertion. The assertion can then be assigned a probability that the assertion is true. Also shown in FIG. 5, an evidence code can be assigned to the assertion that indicates how the assertion was generated, for example, automatically by a method of the invention, or manually by a user that updated the graph.

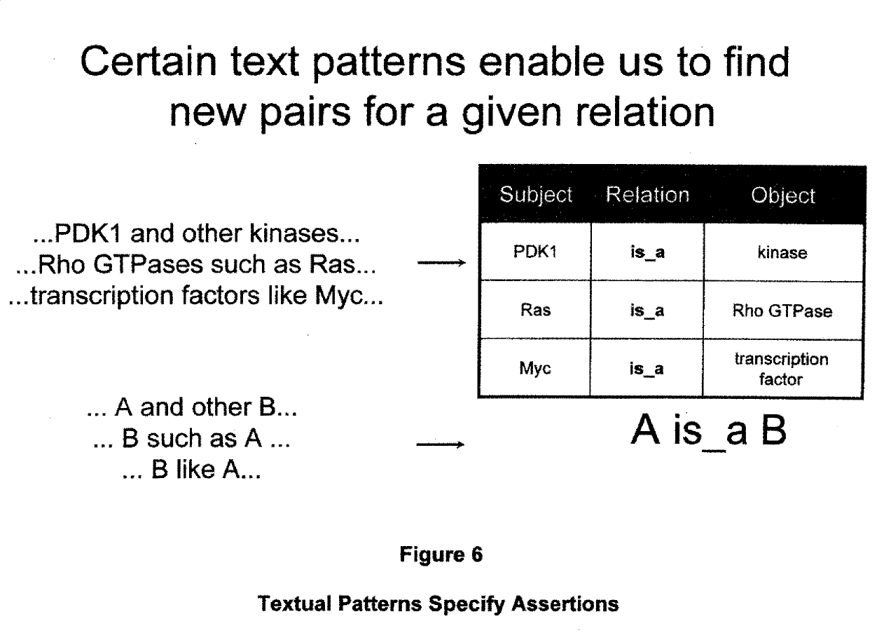

In an embodiment, a manually entered or curated assertion can be assigned a probability of truth of 1(100%). In an embodiment, the user that entered or curated the assertion can assign any probability of truth to the assertion as the user desires. In another embodiment, a system or method of the invention automatically assigns a probability of truth of the assertion to 1 (100%) when the assertion is curated or entered into an ontology by a user. Evidence codes can also be used to denote a method of obtaining the assertion and/or a probability of truth of the assertion. For example, in FIG. 6, a pattern can be extracted from phrases such as “PDK1 and other kinases”, from which can be taken the assertion (PDK1) (is_a) (kinase). This linguistic dependency path (and_other) can be interpreted that every time the form “A, and other B” occurs in a corpus, there is some evidence that (A) (is a) (B) (Hearst, M. (1992) Automatic Acquisition of Hyponyms from Large Text Corpora. Proc. of the Fourteenth International Conference on Computational Linguistics, Nantes, France).

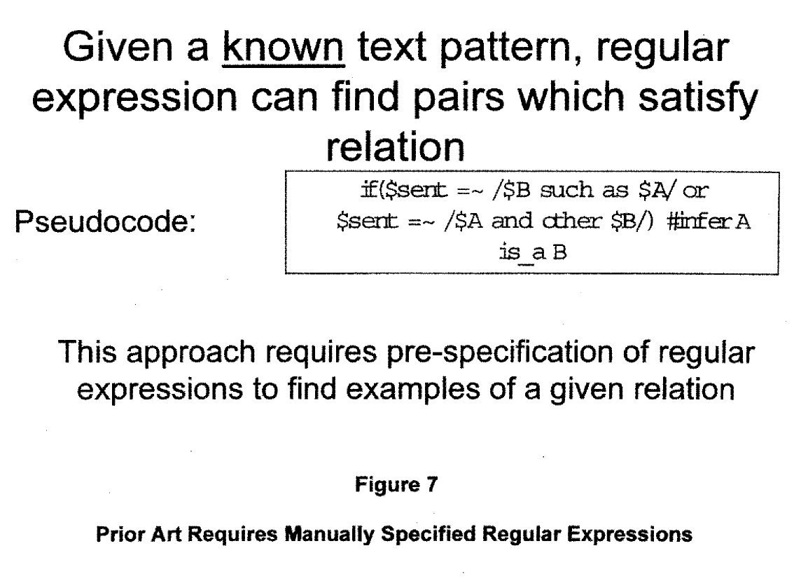

FIG. 7 illustrates an example method of developing a program code to populate an ontology. For example, a pseudocode can be written that requires prespecification of regular expressions to find example of a given relation. In contrast, a method or system of the invention can automatically infer relations between terms without requiring manual coding of linguistic dependency paths.

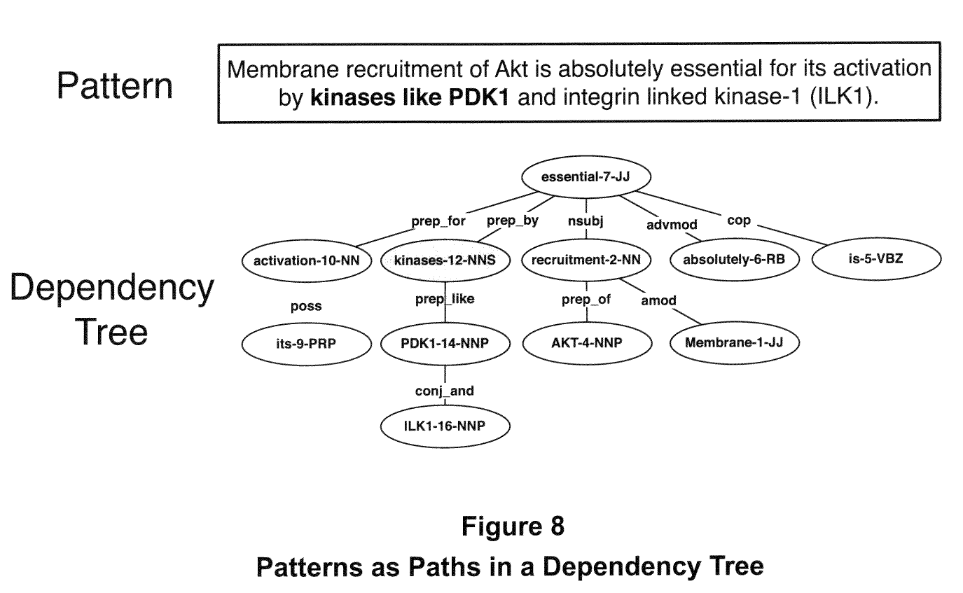

FIG. 8 describes an alternate way of representing a pattern, namely as a directed path in a dependency parse tree. Such paths consist of alternating part of speech terms and dependency types. For a given sentence, the path in the dependency tree connecting two terms represents the linguistic dependency relationship between the terms. Terms which are single words are straightforward to handle. If a term is a multiword unit comprising a subtree of the dependency tree, the path begins at the root of this multiword unit. In the figure, the terms “PDK1” and “kinase” are connected by the directional path “_NNP->prep_like->_NNS”. Here NNP and NNS represent the part-of-speech of “PDK1” and “kinase” respectively, while “prep_like” represents the dependency relation connecting the two. The arrows indicate that this path is directed and not symmetric; the reverse path from “kinase” to “PDK1” is “_NNS<-prep_like<—NNP”.

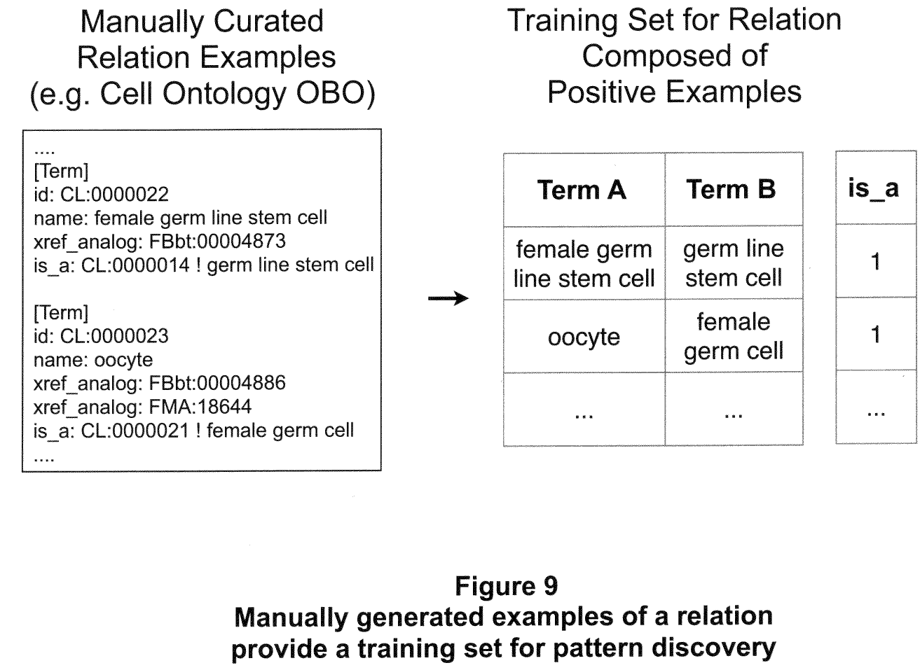

FIG. 9 shows manually generated examples of a relation that provides a training set for pattern discovery. For example, it has been entered by a curator or user that a (female germ line stem cell) (is a) (germ line stem cell), and therefore, the probability of truth of the relation is set at 1 (100%) as shown in FIG. 7. After a training set of true relations has been established (for example, the training set is known data as verified by a person that is curated or entered), a linguistic dependency path counts matrix can be formed. In an embodiment, a path counts matrix is every predicate that connects and two terms (for example, nouns) in a corpus. The linguistic dependency paths can be obtained from the parsed sentences of the corpus.

In this example, by specifying a small training set of subject/object pairs with a known relationship (in this case a training set comprises three such pairs with an “is a” relationship), patterns can be located in the text of the corpus that more generally specify a relationship. These patterns can be applied to the corpus to find many more examples of subject/object pairs with this relationship, vastly expanding the set of known triples beyond the original small training set.

The training set of subject/object pairs can be manually generated or compiled from a known ontology database such as OBO, GO, or UMLS, and the patterns can be formally represented as linguistic dependency paths between two terms, in the sense of a path through a dependency tree (de Mameffe, et al., 2006. Generating Typed Dependency Parses from Phrase Structure Parses. In Proceedings of LREC-06). By using the relationships of linguistic dependency paths from known subjects and objects, a general meaning or relationship for a path can be learned, such as “B, especially A” becomes (A) (is_a) (B). In a preferable embodiment, the relationship between terms is directional in order to extract accurate information from a corpus of literature.

### Generating a Knowledge Graph

In an aspect, the invention discloses a method, typically implemented by computer, for generating a knowledge graph from a corpus of literature having multiple documents. In a first step the corpus is divided into sentences. Each sentence is then parsed into a linguistic dependency path describing a directional relation between the terms. These typically take the form of a sequence of nodes and edges connected two terms in a tree.

Then, a regression problem is generated. The regression problem contains two matrices, a term pair matrix and a relation matrix. The term pair matrix contains pairs of terms related in the corpus by at least one linguistic dependency path. For example, in a corpus of biological information the pair terms could include (MAPK, kinase—“MAPK is a kinase”), (hormone, insulin—“hormones, such as insulin”) and (EGF, EGFR “EGF binds the receptor EGFR”). The relation matrix contains columns, each of which designates a relation to be examined for each pair of terms. The relationships can include hyponym/hypernym relationships such as “is_a”, and a number of more rare relationships, such as “part_of” or “acts_on.”

A path counts matrix also is generated. The path counts matrix is associated with a path lexicon that designates each column of the path counts matrix with a linguistic dependency path. Each cell in the path counts matrix occurs at the intersection of a row designating a term pair and a column designating a linguistic dependency path. The cells are populated with the number of times the pair of terms is represented by the dependency path in the corpus. Preferably, the number of number of times a pair of terms is represented by a linguistic dependency path is sufficiently large that it can be meaningfully subject to logistic regression analysis.

The problem, now, is to assign probabilities to various cells in the relationship matrix so as to indicate the probability that the relationship is true for the particular term pair. To do this, a training set is selected that contains assertions (pairs of terms and a relationship) known to be true and known to be false. A learning algorithm, in particular a sparse logistic regression adapted for use on a cluster, is performed using the path counts matrix associated with the training set to generate a logistic regression model that can evaluate the probability that any term pair satisfies a given relationship.

The model is then applied to the unknown term pairs and relationships and the relation matrix is populated with probabilities for the particular term pair. The combination of a term pair, a relationship and a probability represents a statement. The collection of statements forms the knowledge graph. Typically the knowledge graph will contain many statements. It can be represented graphically as a map in which each term is a node, nodes are connected by edges representing relationships and each set of two nodes connected by relationship has an associated probability. Generally, any term will be connected to multiple other terms in the corpus, creating a web of relationships that can be mined for information. The knowledge graph can be stored on a computer readable medium. In an embodiment, the method further comprises the step of creating a link from the knowledge graph to at least one sentence from which the probabilities were derived. The training data set can be modifiable by a user.

One example method of creating a knowledge graph in accordance with aspects of the invention is to declare a namespace of resource identifiers at the beginning of the file, allowing terms from databases (such as semantic or ontological databases). Each sentence from a corpus can be parsed and can then be represented as a RDF triple, with the members of this triple linked to resource identifiers from the database. For example, EGR1 is a protein with three zinc finger domains, and binding is catalyzed by the presence of zinc. If a user wanted to represent the binding of EGR1 to a particular DNA motif, it can be represented by a set of assertions which would include the following triples:

(zinc) (is_a) (cofactor)
(zinc) (physically_interacts) (zinc_finger_domain)
(EGR1) (is_a) (transcription_factor)
(EGR1_motif) (is_a) (transcription_factor_binding_site)
(domain_1) (part_of) (EGR1)
(domain_1) (is_a) (zinc_finger_domain)

In order to make this machine readable, these assertions can be mapped to the corresponding accession numbers.

(CID:23994) (is_a) (MI:0682)
(CID:23994) (MI:0407) (CDD:pfam00096)
(UniProt:P18146) (is_a) (GO:0003700)
(craHsap:197014) (is_a) (SO:0000235)
(dom:P18146-d1) (part_of) (UniProt:P18146)
(dom:P18146-d1) (is_a) (CDD:pfam00096)

To interpret this, consider the components of the second assertion. CID:23994 maps to zinc in PubChem, MI:0407 maps to physical interaction in Proteomics Standards Initiative—Molecular Interactions (PSI-MI), and CDD:pfam00096 maps to a zinc finger domain in the Conserved Domain Database (CDD). Thus, this example illustrates a method of unambiguously representing the assertion that the small molecule zinc physically interacts with a zinc finger domain.

Many different systems can be used to generate dependency trees from text. Parsers like the Stanford Parser, Clark and Curran's CCG parser, and MiniPar all return dependency tree representations of a sentence. It is also possible to use constituency parsers such as ep4ir in conjunction with a set of head-finding rules to generate dependency trees from a sentence.

In an embodiment of the invention, the probability element is derived from a path-counts matrix from the corpus of literature wherein a column represents a linguistic dependency path, a row represents a pair of terms, and an entry represents the number of times the pair of terms is connected by the path in a sentence. The path-counts matrix can be created from parsed sentences of the corpus of literature.

After a set of paths connecting a pair of terms has been determined, a path-counts matrix can be created wherein the rows are the pairs of terms and the columns are the different linguistic dependency paths of the entire corpus. If an assertion is known, either from a user, for from a known ontology of relationship, such as (A) (is a) (B), the path-counts matrix can be used to determine which other linguistic dependency paths of the corpus might have a similar meaning to (is_a), based on the number of times the path occurs in the corpus. For example, a user may know that (MAPK) (is_a) (kinase) and the machine has found 21 instances of “MAPK” and “kinase” in a portion of the corpus connected by the same linguistic dependency path. The number is shown in the path-counts matrix. Therefore, considering the path-counts matrix may contain millions of paths, a user can understand that the majority of the matrix is zero and even small numbers of entries are important. In the example, the 21 counts belong to the path (such_as), which can now be reasonably inferred by the system to mean (is_a). The inference by the system can be assigned a probability. In this example, because a user knows that (MAPK) (is_a) (kinase), all the path-counts for the connections between “MAPK” and “kinase” can be used as a training set. In addition in this example, the user knows that (MAPK) (is_not_a) (RNA), further strengthening the training set. The user can then use a training set to determine the relationship of two other terms in the corpus. In other embodiments, it is not necessary to have a database of negative training examples as, in general, random pairs of terms can serve as negative examples. In the example, another set of terms is “SHP-1” and “phosphatase”. Because similar linguistic dependency paths from the training set from “MAPK” and “kinase” appear in the path-counts matrix of the corpus for “SHP-1” and “phosphatase”, the machine can infer that (SIP-1) (is_a) (kinase). It is also shown that random paths or errors in the path-counts matrix can appear, such as the counts referring to the path (like). Errors or unsure data could be ignored, however, the knowledge graph of the present invention provides probabilities of a directional relationship between two terms, hence errors or random paths are involved in the calculation of the probability related to the truth of an assertion involving the two terms. In many cases, the more robust paths heavily outweigh the smaller counts in the path-counts matrix and thus, the smaller counts do not skew probability estimation. The inference of an unknown relationship of two terms can be assigned a probability based on path-counts between the two terms of the assertion in respect to the training set. The probability calculation and methods are described herein.

An entry of a path-counts matrix can comprise either a single integer for the number of times the pair of terms is connected by the path in a sentence or a representation of this number as a fixed length boolean vector. The boolean representation can be used to calculate the probability element using a logistic regression algorithm which accepts binary data as input. In an embodiment, the probability element of some statements is automatically generated from a corpus of data. In another embodiment, the probability element of most assertions in the graph is automatically generated from a corpus of data.

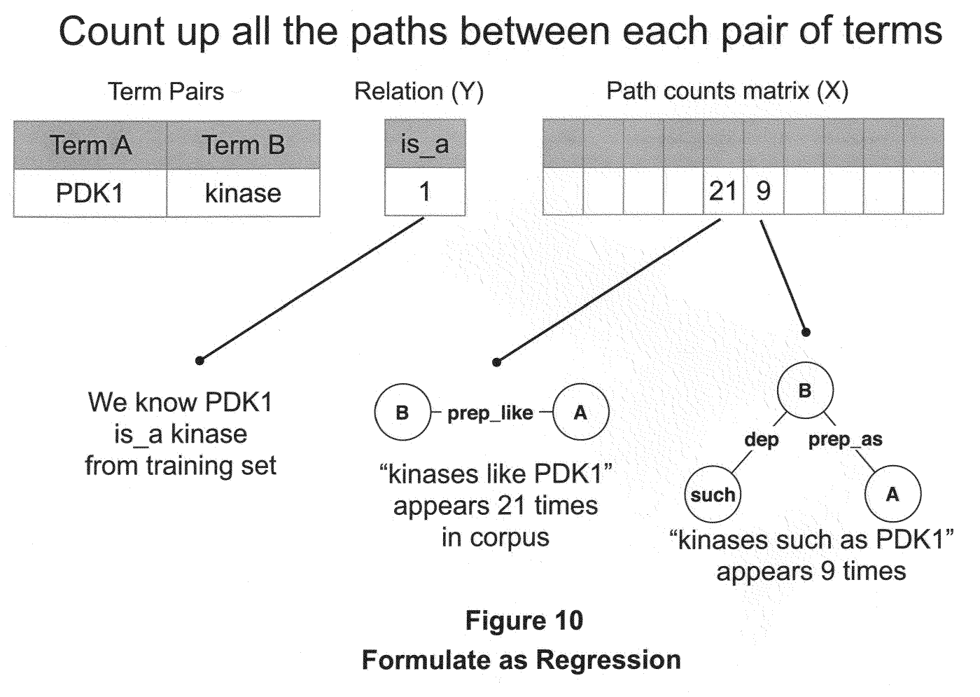

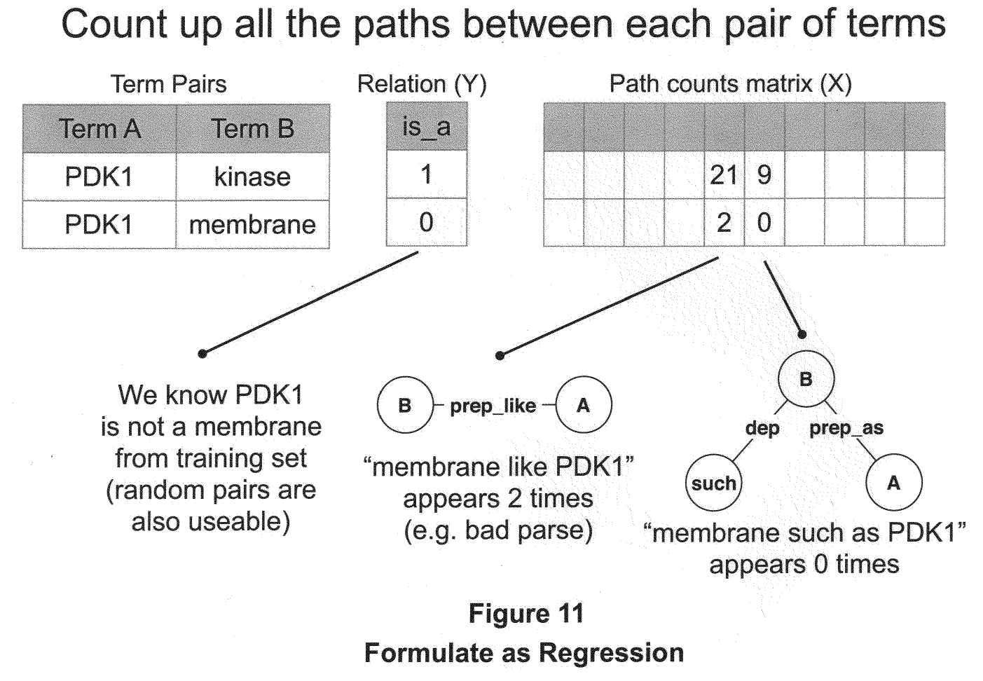

FIG. 10 demonstrates two terms related by an is_a relationship that is known to be true, therefore the probability of truth of the relation equals 1. A path counts matrix is then populated with values for each time a linguistic dependency path is found in the same sentence as the two terms with the known relationship. For example, as shown in FIG. 10, it is known that (PDK1) (is_a) (kinase), and the terms (kinase) and (PDK1) occur in the same sentence as the relation (like) 21 times in the entire corpus. Likewise, the two terms are in the same sentence as the relation (such as) 9 times. Because the assertion (PDK1) (is_a) (kinase) has a probability of 1, it can be used as a training data. Additionally, negative training data can be used, for example we know PDK1 is not a membrane, as shown in FIG. 11.

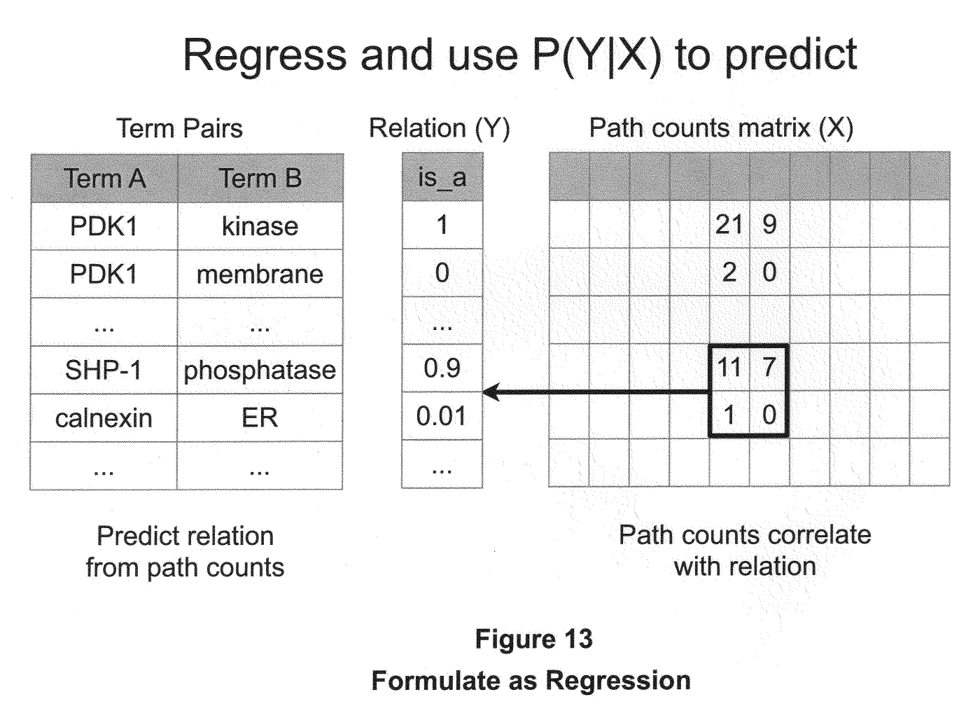

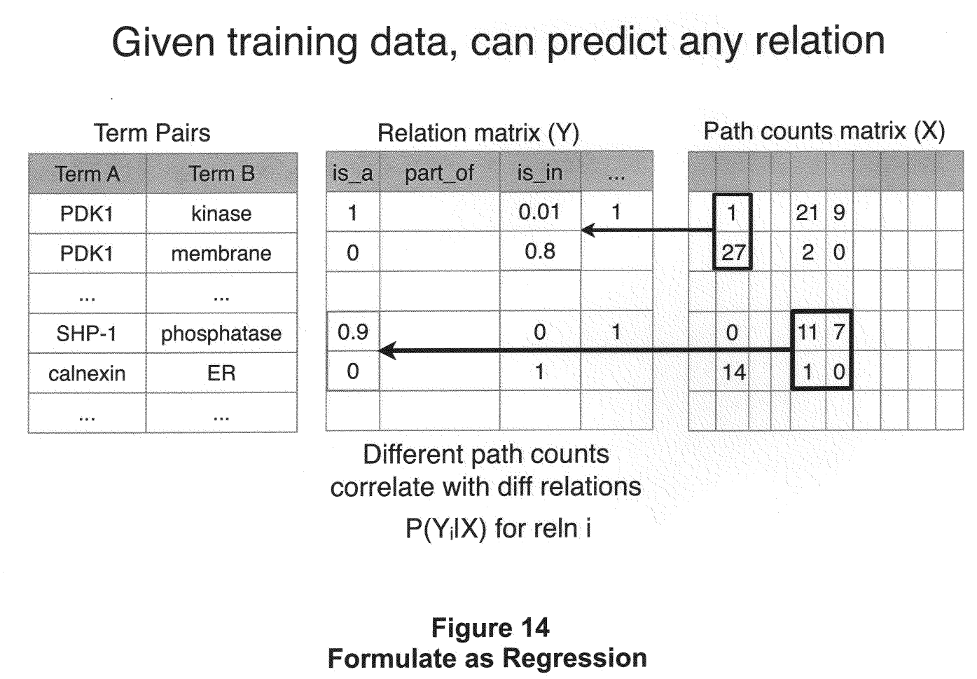

After a training set has been established, a relation between unlabeled pairs can be predicted from the training set. For example as shown in FIG. 13, “SHP-1” and “phosphatase” are found in the corpus 11 times with one linguistic dependency path and 7 times with a different linguistic dependency path. Using sparse logistic regression to compare the path counts matrix to a training set, the assertion (SHP-1) (is a) (phosphatase) can be evaluated to determine a probability of the truth of the assertion as shown in FIG. 13. In an embodiment, given training data, any type of relation can be predicted between an unlabeled pair of terms as shown in FIG. 14.

Sparse logistic regression can be employed for estimating the probability of a relationship applying to a term pair. In brief, the idea behind sparse logistic regression is that we want to use a small set of columns of the X matrix (the path counts matrix) to predict the response variable Y. In one embodiment, the GNU version of the LR-TRIRLS code by Paul Komarek (www.komarix.org) is used to do the computation.

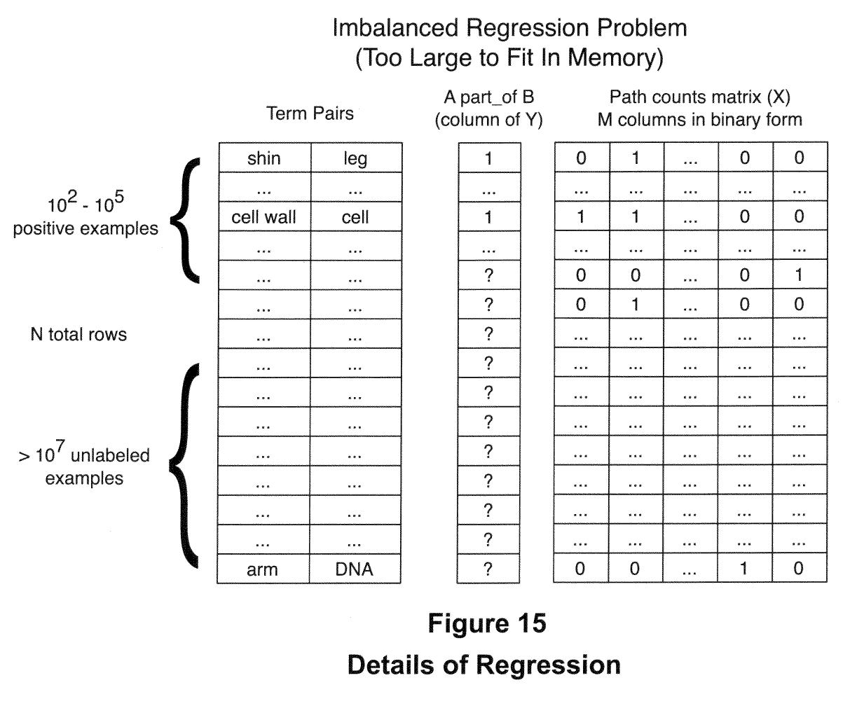

Parallelized version of the code can be used to handle large corpuses. FIG. 15 demonstrates an imbalanced regression problem wherein the problem is too large to fit into main memory (e.g., RAM) of a computer system. Using a training set of about 10² to 10⁵ positive examples and greater than 10⁷ unlabeled examples with millions of linguistic dependency paths is a path counts matrix is too large a set of information to perform logistic regression.

FIG. 15 demonstrates a large regression problem, such as a method of the invention, wherein a table for use with regression is significantly larger than the main memory of a computer system. For example, there may be more than tens of millions of columns in the path counts matrix and more than tens of millions of rows corresponding to a pair of terms. Using unlabeled pairs as negative examples in a training set, the rows of the table of FIG. 15 can be divided into smaller subsets of tables, wherein every subset comprises all of the positive examples from the training set and a random undersampling of the negative examples (now all the unlabeled pairs). In an embodiment, the number of subsets of the logistic regression problem depends on the available computer main memory. In another embodiment, the number of subsets is determined by a user.

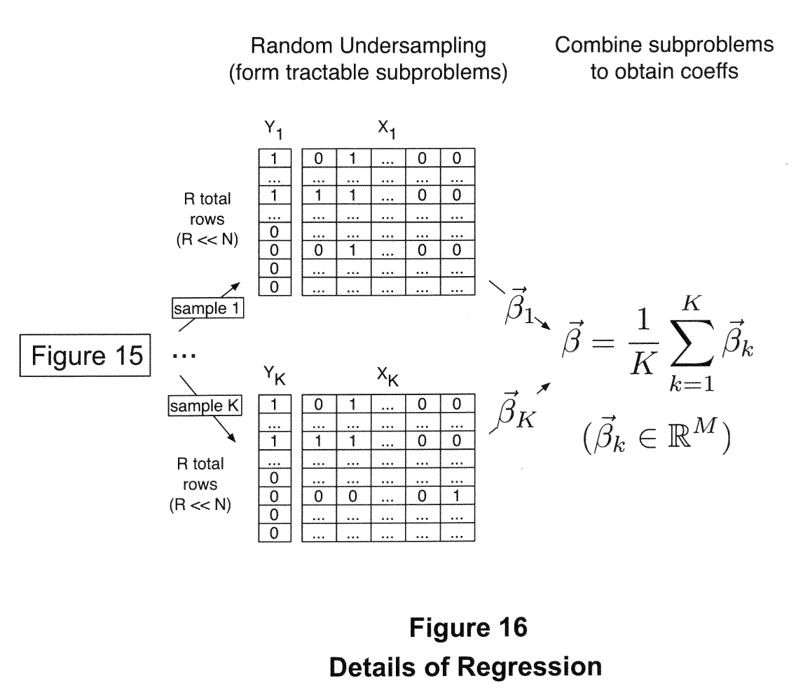

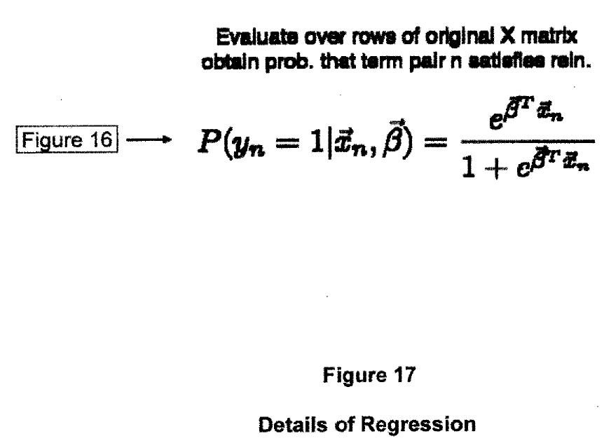

After the problem is FIG. 15 has been split into subsets, sparse logistic regression can be carried out on each subset to determine the regression coefficients of the path count columns of the path counts matrix for each subset as shown in FIG. 16. The regression coefficient vectors of the subsets can then be merged using bootstrap averaging to obtain an overall regression coefficient vector. The overall regression coefficient vector can then be used to evaluate over each row in the table to obtain the probability that an unlabeled term pair satisfies the relationship as shown in FIG. 17.

The same method can be used to create automatic assertions and the probability of truth of the automatic assertions for any type of assertion including, for example, a hypernym/hyponym relation and meronym/holonym, or any other non-hypernym/hyponym relations.

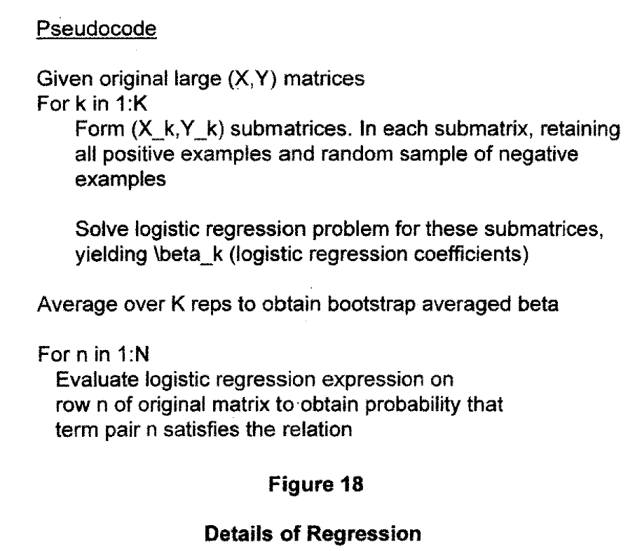

FIG. 18 illustrates example pseudocode for carrying out a sparse logistic regression problem of the invention.

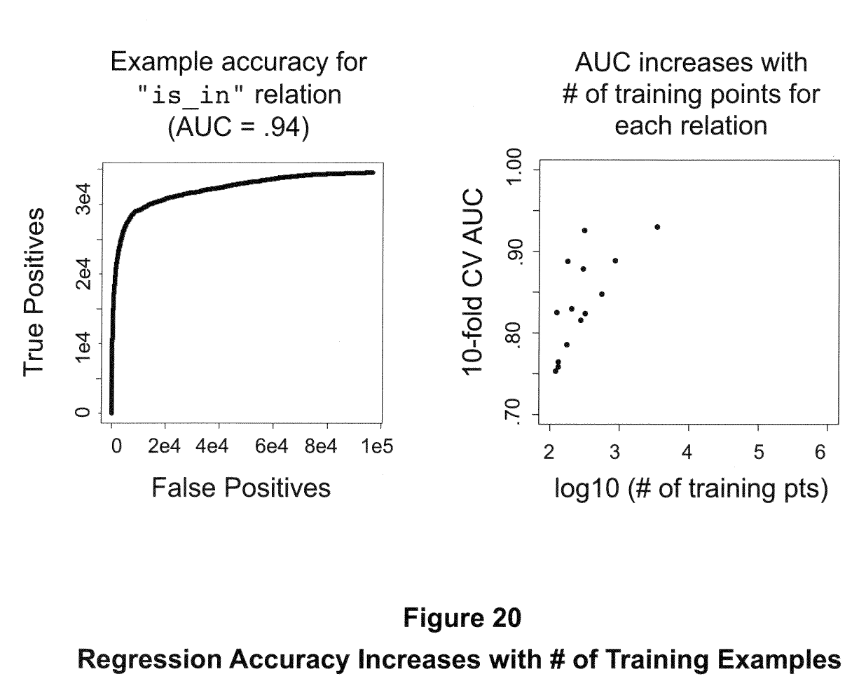

FIG. 20 demonstrates how to evaluate the extent to which the algorithm has learned a given relation. The relation extraction algorithm can be viewed as a binary classifier, and a standard metric of binary classifier performance is the AUC, the area under the receiver operator characteristic or ROC curve. A random classifier has an AUC of 0.5 and a perfect classifier has an AUC of 1.0. In the left panel an example ROC curve for the “is_in” relation is depicted. The AUC for this relation is 0.94, indicating that it was accurately learned by the algorithm. In the right panel, the dependence of the AUC on the number of training examples is depicted. Importantly, the AUC of the classifier exceeds 0.95 once approximately 10000 training examples are provided.

Other regression techniques or supervised learning method for estimating probabilities can also be used, such as random forests. The key constraints on any such algorithm is that it (1) scale to large datasets with millions of rows and tens of millions of columns, (2) produce models which can be easily combined via boosting, bootstrapping, or a similar model averaging method, and (3) handle datasets with significant statistical dependence between columns. The Naïve Bayes algorithm, for example, does not satisfy criteria (3), while standard logistic regression does not satisfy criteria (1). In some embodiments, multiple relations can be predicted simultaneously for a given subject/object pair. In most cases, however, equivalent performance is obtained by predicting each relation independent of the others, allowing the use of regression methods which produce univariate responses.

In some embodiments, a random undersampling of negative examples can be used in order to process a large number of examples using a computer implemented method of the invention. In these embodiments, for each sampling repetition, a submatrix can be extracted that contains all the positive examples and a random set of negative examples. The ratio of negative to positive examples can be made as large as possible given available main computer memory. For each submatrix a classifier can be run to derive a model that predicts Y (the binary variable indicating whether the relation holds between a pair) from X (the path-counts submatrix). The models and predictions from these models can then be averaged across sampling repetitions. A random undersampling technique is supported by both empirical and theoretical arguments, because the coefficients in a logistic regression approach a stable limit as the ratio of negative to positive pairs becomes large (Van Hulse, et al., 2007, Experimental Perspectives on Learning from Imbalanced Data. In Proceedings of the 24th International Conference on Machine Learning, Corvallis, OR and Owen, 2007, Infinitely Imbalanced Logistic Regression. Journal of Machine Learning Research).

For rare relations, it can be difficult to find sentences in the corpus which contain term pairs satisfying the relation. To address this problem, the corpus can be augmented by the use of a search engine. Specifically, consider the following pseudocode, which is similar to a Python implementation:

```
AugmentCorpusByWebSearch(term_pair_list,
corpus_file, path_counts_matrix_file):
    #Given a list of term pairs, the corpus_file, and
    the path_counts_matrix_file,
    #augment the corpus & path counts matrix by
    parsing text from web pages which
    #contain the term pair. The purpose is to alleviate the scarcity of
    #sentences containing a training pair.
    for term_pair in term_pair_list:
        search_query = ‘“term1”’ + “ ” + ‘“term2”’
        web_pages_with_term_pair =
        Run_Web_Search(search_query)
    for web_page in web_pages_with_term_pair:
        text = extract_text_from_web_page(web_page)
        add_text_to_corpus(text,corpus_file)
        update_path_counts_matrix_from_text(text,
        path_counts_matrix_file)
    return( )
```

This function queries a search engine with a pair of terms from the training set which ostensibly satisfies a relation. If any sentences on the entire web (including the majority of the scientific literature) contain both terms in the pair, they will be returned as a list of web pages. These web pages can then be downloaded to add to the original corpus and parsed to update the path counts matrix. The value of doing this is that it becomes much easier to learn the sentence paths which predict rare relations as the rows of the relation matrix containing positive examples will be paired with corresponding rows in the path counts matrix that have many nonzero entries. Major search engines generally limit such queries to one per second, or 86400 queries per day; this is more than enough to provide tens of thousands of pages of high quality training data for any relation type.

It is both possible and extremely useful to generalize the algorithm to process arbitrary content areas, including those which do not have predefined ontologies. Consider the following pseudocode.

```
For each focused content corpus:
  Parse corpus into dependency trees and generate path counts matrix X
  while(TRUE):
    Enumerate key relations in the content area
    Enumerate key terms in the content area
    Optionally, run Named Entity Recognition on corpus to
    augment term list
    For each key relation:
      while(TRUE):
        Enumerate term pairs which satisfy relation, thereby
        specifying training set
        Optionally run AugmentCorpusByWebSearch(term_pair_list,
        corpus_file,path_counts_matrix_file) to update
        path counts matrix
        Encode training set as column of relation matrix Y
        Run distributed sparse logistic regression, returning AUC
        as well as coefficient vector and relation predictions
        If AUC is low:
          Relation is difficult to learn; either add training examples
          or break & discard relation
        If AUC is moderate:
          Review and curate term pairs returned by algorithm which
          have high probability; add correct term pairs to enumerated
          list, thereby bootstrapping training set
      If AUC is high:
        break as relation successfully learned
  If enough relations learned at high enough AUC:
    return final coefficient matrix and predict relations
    satisfied by all term pairs
    break & end indexing of content vertical
```

This code outlines a general strategy for populating ontologies and extracting relations from text in a given focused content area. By “focused content” we refer to a corpus that is not the entire web, but a text corpus that deals with a coherent subject area such as biomedicine or finance.

The idea behind the code is that a small effort in manual enumeration of term pairs which satisfy a given relation can be used to bootstrap the process of ontology population. For example, given even 100 terms which satisfy the “is in” relation, a classifier with moderate AUC can be learned. The resulting assertions with high veracities can be reviewed and processed to yield an updated, significantly larger set of term pairs satisfying the “is_in” relation. This is essentially a computer-aided positive feedback loop which allows rapid population of an ontology. The end result is a set of regression coefficients for each ontological relation as well as a semantically marked up corpus.

Note that an important constraint here is the parsing step. The current generation of statistical natural language parsers such as the Stanford Parser is relatively slow and is the bottleneck in the relation learning algorithm. This limitation is not particularly pressing when considering a focused content area; for example, there are roughly 16 million articles in PubMed, with approximately 400 sentences per article. At a parsing rate of 2 sentences per second (roughly the speed of a node in a commodity cluster in early 2008), it would take approximately 37000 days or 100 years of computer time to process every biomedical article ever written. This is a one time cost and easily completed on the clusters with many hundreds of thousands of nodes that are currently employed at the major search engines. After the completion of this up front cost, maintenance is extremely cheap as new content in virtually every domain other than the entire web is generated at a rate far below Moore's law. Many other high value focused content areas (e.g. the entire corpus of the New York Times, the entirety of the Congressional Record, or the set of digitized discharge summaries) have similar characteristics in that a one-time computation suffices to backfill all previous data, with subsequently cheap maintenance.

When utilizing a method for calculating probability that provides several different weight vectors for columns in the path-counts matrix, model averaging methods can be used to combine these regression coefficients into a single weight vector for the purposes of prediction. In one embodiment, simple bootstrap averaging of regression coefficients and predicted probabilities over random undersampling repetitions is used to robustify against the possibility of an unrepresentative sample. The resulting averaged regression coefficients rank the different paths by the extent to which they predict the relation. For example, the top ranked path for predicting whether (X) (is_involved_in_biological_process) (Y) is “_-NNP<-nsubjpass<-required-VBN->prep_for->_-NN”. An example of a sentence containing this path is “Albumin was required for the LCAT reaction”, which implies that (Albumin) (is_involved_in_biological_process) (LCAT reaction).

Given a small training set of pairs of terms with known relationships such as “is a”, “develops from”, or “regulates a”, the method can learn lexicosyntactic patterns which specify this assertion in plain text. This training set can be generated manually or by using extant ontological databases such as the Unified Medical Language System (UMLS) and the Open Biomedical Ontologies (OBO). The learned patterns can then be used to find many more examples of objects that satisfy these relationships. Each such assertion is a triple, composed of a pair of terms (such as a subject and an object) and a relationship (such as a predicate). For example, “CtrA regulates CckA”. The method assigns probabilities related to the truth of the triple (assertion) based on the training data. The frequency of phrases in the training data affects the probability of the relationship. For example, suppose that there are 1000 pairs of proteins in which protein A is known to phosphorylate protein B in our training set. Suppose further that these pairs frequently tend to be mentioned in text as “A phosphorylates B”, and less frequently as “the activator of B is A”. Then for a new pair of proteins X and Y, the occurrence of the phrase “X phosphorylates Y” contributes more to the probability that X does in fact phosphorylate Y than the phrase “the activator of Y is X”.

The machine learned linguistic dependency paths can be utilized over a variety of different ontologies. For example, both gene and cell ontology can be related to each other over an entire corpus of biomedical literature, such as the journals on PubMed.

In an embodiment, the method can comprise constraints on inferred relationships given a training set. For example, given that protein A is part of complex C, if some text indicates that B is also part of complex C, it can be inferred that A is likely to physically interact with protein B as well. Assignment of a probability to the inference of the interaction can allow a user to understand the importance of the relationship and assertion. Chains of constraints between different ontological relationships can allow compensation in part for sparsity of data.

In an embodiment, the invention features a method of searching a corpus of literature comprising obtaining the link from a back-trace object of a knowledge graph in accordance with aspects of the invention. When a link is obtained, the method can further comprise displaying the portion of the corpus from which the assertion was obtained. In an embodiment, a back-trace object is an object which generates the set of sentences which contributed to the relation on demand. For example, by executing a stored procedure on a SQL database or a cached set of sentence IDs.

In order to visualize a knowledge graph from a corpus, a web interface can be used for generating a model. For example, when visualizing scientific articles, the interface can allow users to immediately view when a new assertion has been discovered in a scientific field or system of interest.

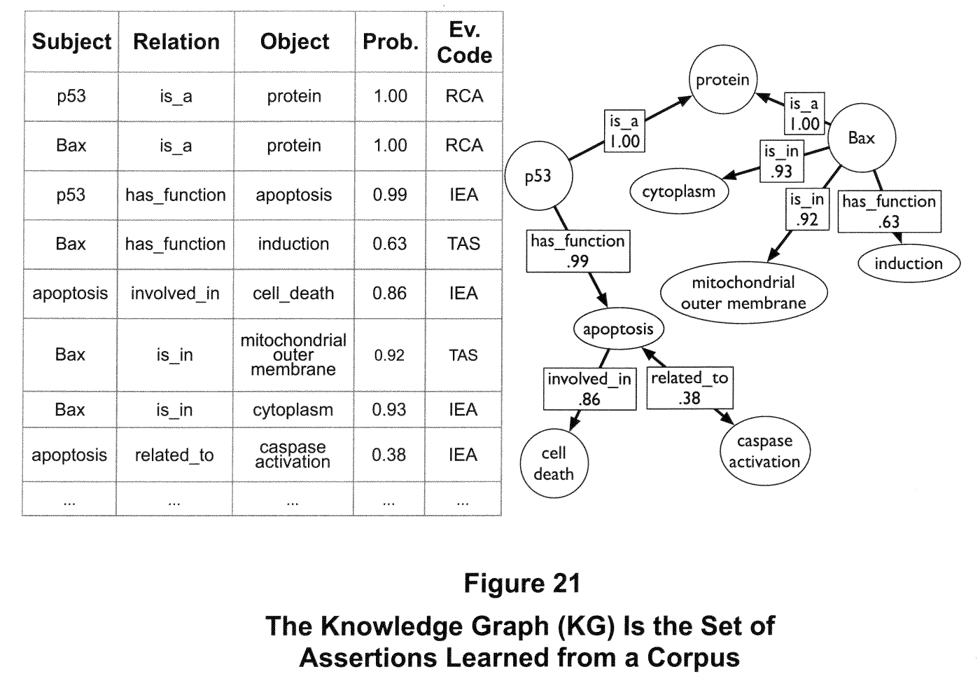

FIG. 21 illustrates an example of two different representations of knowledge graph of the invention. On the left of the figure, a knowledge graph is represented as a table of statements wherein the statements further comprise an evidence code as described herein. The probabilities of the assertions that do not equal 1 may have been automatically calculated by a sparse logistic regression method of the invention. On the right of FIG. 21, a knowledge graph is represented as a graph with nodes and edges, wherein the nodes are terms and the edges are directional relations. The edges in the example have been assigned probabilities of the truth of the relation as shown in FIG. 21.

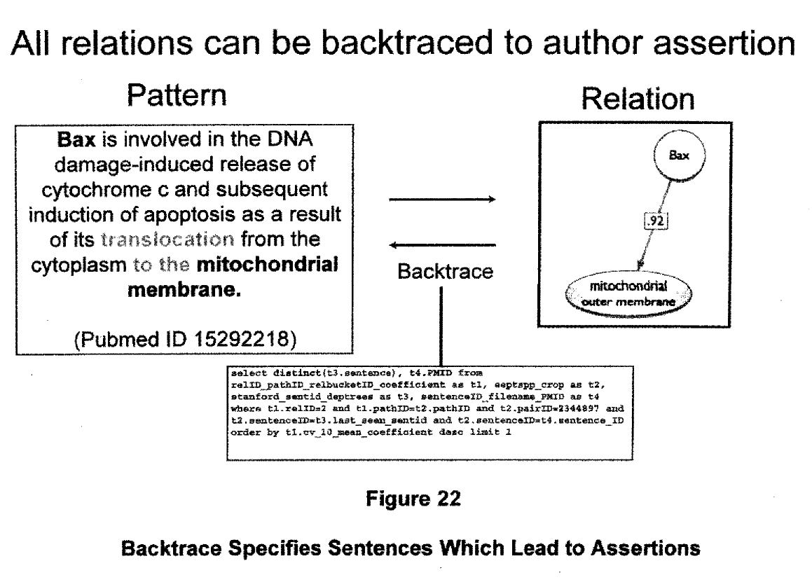

FIG. 22 illustrates an example of a method of using a back-trace object. For example, an assertion of the knowledge can be associated with a back-trace object that links the assertion back to particular portions of the corpus from which the assertion was automatically generated. The back-trace object can also be used as a search tool to investigate the portion of the corpus that had significant influence (for example, high regression coefficient of the linguistic dependency path) in formation of the assertion. FIG. 22 illustrates a pattern in a sentence that can assist in learning an assertion for automatic population of a knowledge graph. A back-trace object allows a user to select the assertion of interest from a knowledge graph and investigate the portion of the corpus that contains the pattern in a sentence that assisted in learning the assertion.

In another aspect, an automatically produced structural digital abstract of a document comprising a machine readable abstract is disclosed that comprises a plurality of statements wherein a statement comprises at least four elements. Of the at least four elements, two elements are terms, one element is a directional relation that connects the two terms to form an assertion, and one element is an estimated probability that the assertion is true or false.

A probability element of a structured digital abstract in accordance with aspects of the invention can be generated by applying rules determined using a path-counts matrix produced from parsed sentence entries from a corpus of literature, wherein a column in the path-counts matrix represents a linguistic dependency path, a row represents a pair of terms, and an entry represents the number of times in the corpus the terms are connected by the path in a sentence.

### Structured Digital Abstracts

This invention also provides machine readable abstracts of articles in a corpus and methods of generating them. The abstracts are useful for searching for articles related to a particular topic. In one method a structured digital abstract is generated by first dividing an article in the corpus into sentences. Then, the sentences are parsed. A path counts matrix is generated that is populated by counts for paths for pairs of terms in the article. Then, the regression model is applied to the data to determine probable assertions in the article. The collection of assertions represents the abstract.

In an embodiment, assertions of a structured digital abstract further comprise a link to the portion of the corpus from which the assertion was derived.

As opposed to a manually-formatted machine readable abstracts as described previously (Gerstein, 2007, http://www.biomedcentral.com/1471-2105/8/17), the content of an article or portion of a corpus as represented as an automatically generated SDA structured in a knowledge graph format is disclosed herein. The automatic generation of an SDA can allow for a much greater degree of confidence in assertions and probabilities relating to the truth of the assertion, as well as making it easier to compile assertions from a large corpus of literature. The invention disclosure herein pertains to an automated system for algorithmically generating machine readable content via natural language processing. In some embodiments, the present invention uses triplet representation of assertions. By using a triplet representation of assertions and additional representations of probabilities as a three (or four) column human editable file, in either the N3 notation for RDF (editable in a text editor) or as a spreadsheet, the SDAs in accordance with aspects of the invention offer a practical method of structuring large amounts of information. In this context, certain embodiments of the present invention allow a user to define a universally applicable document type definition (DTD) by a user or group of users to cover an entire corpus, such as biomedicine. In contrast, typically XML is intended for top-down, hierarchical, centralized knowledge whereas RDF suitable for bottom-up, organic, distributed knowledge.

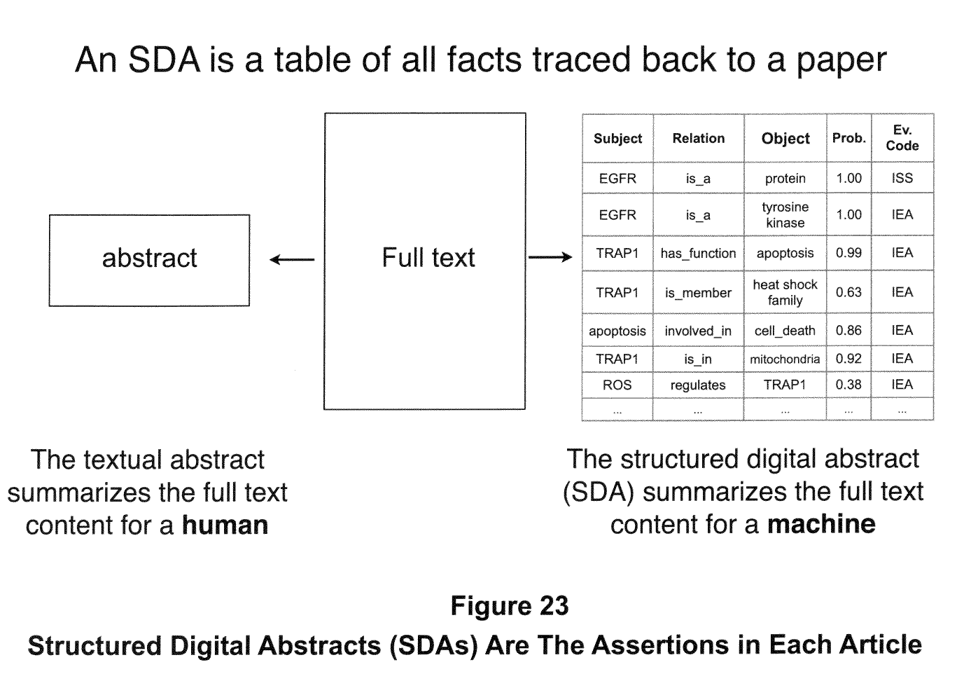

FIG. 23 illustrates an expansion of a method of automatically generating a structured digital abstract. A table can be created that summarizes all the assertions in an individual article or portion of a corpus using a method of the invention. FIG. 23 illustrates a traditional textual abstract and a structured digital abstract. The assertions of the structured digital abstracts can be facts as determined by a user or author. In an embodiment, a knowledge graph of the invention can be a collection of structured digital abstracts of the invention. In another embodiment, an author or user of a structured digital abstracts can manually curate the abstract, and thus, the SDA can be used for training data for automatic ontology population.

A knowledge graph and/or SDA in accordance with aspects of the invention can aid in the communication of scientific results across linguistic barriers. If the content of an article is expressed in terms of triples of universally agreed upon accession numbers, it may be easier for a researcher in a non-English speaking country to understand the content of the text.

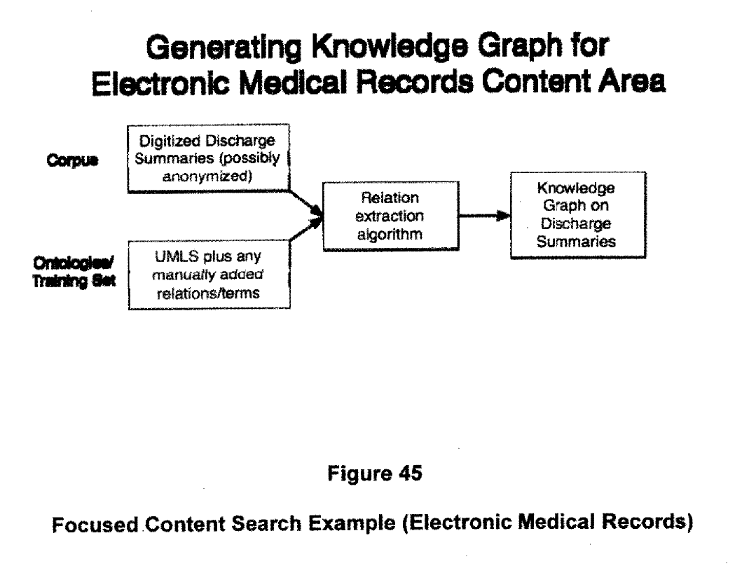

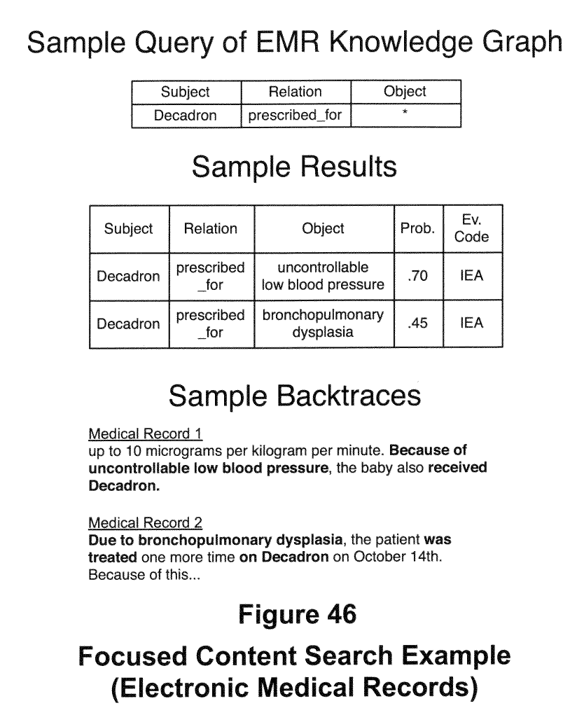

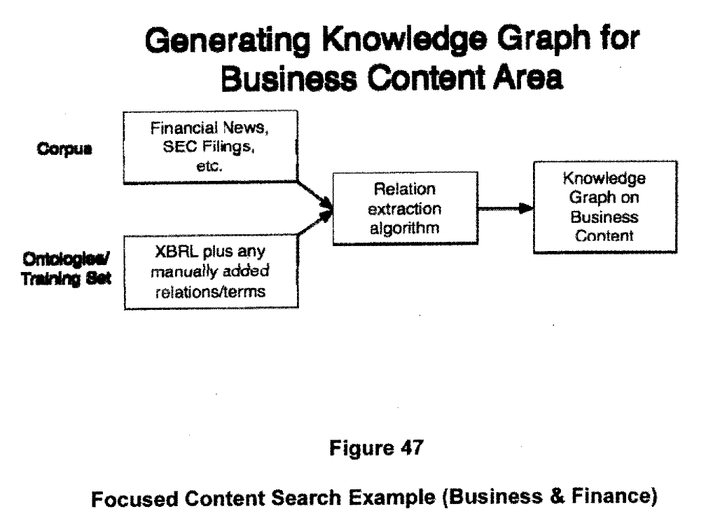

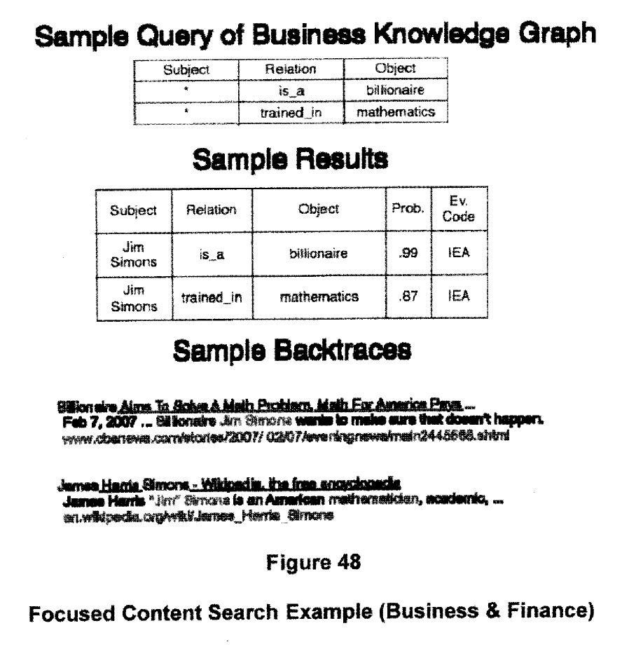

Areas other than science utilizing a knowledge graph or SDA in accordance with aspects of the invention include, but are not limited to, generating summaries of technical or policy documents more generally. For example, the literature can be textbooks, medical advisory bulletins, historical accounts, policy documents, etc. See the pseudocode above regarding focused content corpus indexing and FIGS. 45-48 for details.

Different grammar for a specific application can also be optimized by a caretaker or user in accordance with aspects of the invention.

In a preferable embodiment, sentence boundaries are detected via regular expressions. However, text data harvested from web pages is often quite messy and involves periods, question marks, exclamation marks and other punctuation in unexpected regions. A machine learning based algorithm can be implemented to deal with this problem by automatically recognizing sentence boundaries.

In another embodiment, recognition of multi-word units (for example, “Addison's disease” or “adrenal gland carcinoma”) can be obtained from disparate domains. Permutation and alphabetical canonicalization followed by dictionary based lookup can be used for multi-word recognition. For example, given “carcinoma of the adrenal gland”, strip stopped words can give “carcinoma adrenal gland”, permute and alphabetically order to give “adrenal gland carcinoma”. The multi-word term can be found in a table of terms to find the resource identifier. A machine learning based algorithm can be implemented for named entity recognition of multi-word units. In addition to morphological features, word synonymy, and word-order based features, this algorithm may match subtrees of the parse tree of a sentence to parse trees generated by a lexicon of multi-word terms. This parse tree based matching allows for recognizing different variants of the same multi-word unit.

In yet another aspect, the invention offers a method of semantically searching biomedical literature comprising: providing a search string, wherein the string is at least one of a term, a relation, and an assertion of two terms with a directional relation linking the terms; comparing the search string with a knowledge graph produced from a corpus of literature which is stored on a computer readable medium comprising a plurality of statements, wherein each statement is obtained from sentences within the corpus, each statement comprising at least four elements; ranking the statements obtained from the back-trace object that are most closely related to the search assertion; and displaying a representation of a subset of the statements that are closely related to the search string. Of the at least four elements of each statement, two elements are terms; one element is a directional relation that connects the two terms to form an assertion; one element is an estimated probability that the assertion is true or false; and one element is a back-trace object that provides a link to the portion of the corpus from which the assertion was obtained.

In an embodiment, a method of searching biomedical literature further comprises displaying a sentence from the corpus from which the statement was obtained using the back-trace object. In another embodiment, the method further comprises displaying a reference (such as an article or journal citation) from the corpus from which the statement was obtained using the back-trace object. When displaying the portion of a sentence from which the statement, the portion can be highlighted.

In an embodiment, a method of displaying text from a corpus of literature uses a back-trace object of a knowledge graph in accordance with aspects of the invention. For example, if a user searches the string “MAPKK”, different assertions relating to the term can be displayed with a probability relating to the truth of each assertion. The user can select the assertion he wishes to explore, and one of the portions of the corpus from which the assertion arose can be displayed. In another embodiment, a user can conduct a research study based on a supposed assertion, such as one that may only be linked through a series of linguistic dependency paths, and needs to be verified. If the assertion is verified or shown to be false, the known assertion can be added to the training set.

When a large amount of research is automatically reduced to a knowledge graph by a method in accordance with aspects of the invention, many applications can be enabled. For example, the semantic search of complicated biomedical text with complicated terminology can be adapted to understand relationships between objects or terms. Given a set of tables of facts for each paper (for example, an RDF triplestore linked to data on papers such as publication date, authors, and citations), SQL and SPARQL queries can be issued to ask questions, such as the following: “which proteins are phosphorylated by PDK1? ”, “which biological processes regulate aging?”, “which paper was the first to discover that CtrA is a cell cycle regulator?”. Such questions can move well beyond keyword based search and are particularly useful for searching a large corpus of literature. In addition, when searchers are technically competent and/or highly motivated to seek the correct answer, a search method in accordance with aspects of the invention may be very useful for expanding and understanding search results.

In an embodiment, the ranking of the statements is determined by at least one of the criteria selected from the group consisting of: the extent to which the statements match the search assertion, the impact factor of the reference from which the statements were derived, the number of citations to the papers from which the statements were derived, the number of citations to the authors of each paper, the number of citations involving topics which the paper covers, the time at which these papers were published, and the extent to which a given statement is central to a given topic. Weighted averages or combinations of these criteria along with empirical usage statistics (e.g. from visitor logs and queries) can be used to further optimize retrieval.

In certain embodiments, the knowledge graph can be a structured digital abstract, an RDF, or a probablistic RDF.

In an embodiment, entering search terms comprises issuing SQL and/or SPARQL queries and/or looking up previously computed results in a distributed memory object caching system. In an aspect of the invention, a computer implemented method of searching the internet comprises: methodically searching documents on web pages; extracting the content of the pages with a program that utilizes a path-counts matrix, pairs of terms, and corresponding relationship probabilities derived from a corpus of literature to extract pairs of terms and calculate probabilities for relations between the terms; and storing the extracted content of the pages in a computer readable format.

The invention also provides a computer program product for generating a knowledge graph or structured digital abstract in accordance with aspects of the invention on a computer readable medium. The computer program product can comprise code that when executed carries out a method of the invention or creates an object in accordance with aspects of the invention on a computer readable medium.

In an example, an executable linked to a word processor can be used to determine the assertions and their related probabilities in a portion of the corpus. This can be displayed as a structured digital abstract.

A web interface for users to dynamically update the assertions associated with a given portion of the corpus can be used to modify and maintain ontological relationships. The interface can be a spreadsheet of 3-column fields, representing an ontological relationship or assertion, which can fit in a sub-frame of a larger page. A spreadsheet can also incorporate a fourth column with the probability related to the truth of an assertion. Users can enter assertions into fields to add concepts that were missed by a computer implemented method of the invention and/or a user. The interface can check user-specified assertions against valid resource databases (for example, Gene Ontology (GO)) to verify that each assertion is indeed mappable to a resource. The interface can also use a Captcha to prevent spam and logs IPs.

After training, a computer implemented method can produce a set of coefficients which describe the extent to which different linguistic paths predict different ontological relationships. For example, the occurrence of the phrase “B's, such as A” is strong evidence for the assertion (A) (is a) (B) and the coefficient for this phrase would be high. Typically, the set of coefficients with a significant value is actually quite sparse for most relationships of interest. As such, a small, lightweight computer executable product can be developed which can be included in a multi-threaded, deployed application, such as a web browser. This would reduce the cost of detection of ontological relationships in a given piece of text to (1) a parsing step and (2) a function evaluation using this coefficient vector. The reason this is useful is that it could potentially enable web search to generalize to areas in which there is not much in the way of hyperlink structure.

An ontology can be automatically populated using the semantic searching and machine learned methods in accordance with aspects of the invention. Curators of the ontology may go through many ontological relationships (for example, around 1000) and examine the probabilities related to the assertion from the corpus. If the curator knows the assertion to be true or false, the curator can manually edit the information to form the training set for a method in accordance with aspects of the invention.

Using the probabilities associated with a knowledge graph in accordance with aspects of the invention, different relationships between terms can be discovered. In addition, the probabilistic weighing of the edges can allow for identification of sections or assertions of the ontology that have poor evidentiary support.

An example of a common prior art method of developing a relationship model for an ontology is a user searches a database (such as PubMed), reads the related portions of the corpus (such as scientific articles), and then manually constructs a model. Various methods of the invention enable a user to extract assertions from a corpus of literature and automatically populate a model of the corpus. The model can be a knowledge graph or structured digital abstract in accordance with aspects of the invention. Because the method is computer implemented, many more assertions can be handled and discovered than is possible by a human user. In an example matrix relating to a knowledge graph in accordance with aspects of the invention, each of the triples can be assigned a probability that the assertions of the triples are true or false. When new literature is added, probabilities can be recalculated. The corpus can be updated automatically, and the training data can be reformatted by a curator, if necessary.

In another aspect, the invention pertains to a business method comprising: entering into a contract with an owner of a corpus of literature to produce a knowledge graph from their corpus; producing a knowledge graph by creating a path-counts matrix from the parsed sentence entries from the corpus of literature wherein a column represents an linguistic dependency path, the rows represent a pair of terms, and the entries represent the number of times the terms are connected by the path in a sentence, wherein revenue is derived from the use of the knowledge graph that was generated from the owner's corpus of literature. In an embodiment, the revenue is derived by selling ad space on a web page that allows search of the knowledge graph. In another embodiment, the revenue is derived by selling access to the database.

The various embodiments of the invention contemplate separate CPU-based systems implementing respective portions of methodologies discussed herein. All of the CPU-based systems can implemented by a single entity. One or more of the CPU-based systems can also be operated by separate entities.

The examples and other embodiments described herein are exemplary and are not intended to be limiting in describing the full scope of apparatus, systems, compositions, materials, and methods of this invention. Equivalent changes, modifications, variations in specific embodiments, apparatus, systems, compositions, materials and methods may be made within the scope of the present invention with substantially similar results. Such changes, modifications or variations are not to be regarded as a departure from the spirit and scope of the invention. The following claims are directed to, without limitation, various embodiments of the present invention, including for example, systems, methods, graphs and database structures.

### EXAMPLE 1

In biology, the construction of knowledge graphs for key model organisms integrating multiple data types can incorporate explicit models of uncertainty, and include ontologically typed edges and nodes. However, knowledge graphs should exclude conditional interactions.

One of the most important lessons learned from genome sequencing was the value of the Gene Ontology's (GO) systematic, machine-readable approach to categorizing function. Before GO, it was difficult for a computer to discern that a protein annotated as an “alcohol dehydrogenase” was a kind of oxidoreductase. A similar state of affairs may be currently prevalent in systems biology, and a knowledge graph in accordance with aspects of the invention may prove to be an essential tool. The knowledge graph can derive largely from existing ontologies, something like a more focused analog of the Unified Medical Language System for systems biology. Such an ontology would allow rich kinds of logical and statistical reasoning to be applied in a network context. Many of the terms for the knowledge graph and assertions of the knowledge graph can be derived from existing ontologies like the Gene and Sequence Ontology and from lists of canonical identifiers such as those available through Entrez Gene, UniProt, CDD, and PubChem. There are also several available standards in the systems biology space which can serve as building blocks for the linguistic dependency paths of the knowledge graph including, but not limited to, SBML, CellML, BioPax and PSI-MI. By combining these source vocabularies, a knowledge graph may provide a unified framework for defining a reference network and its associated metadata, in terms of lists of triples with probabilities related to the truth of the triples (or assertions). Each triple corresponds to an assertion within the network or corpus, represented as a subject/predicate/object/probability tuple of uniform resource identifiers (URIs). Each URI represents a canonical identifier drawn from one of the established databases or ontologies. Given a consensus set of URIs for biological objects, an explicitly typed reference network can then be naturally represented as a set of ontological triples with probabilities, such as “A physically_interacts_with B” with 90% confidence, or “X is_a Y” with 100% confidence, in which canonical URIs are used for each member of the triple.

Representing network data as a knowledge graph using the same URIs across multiple locations can be particularly useful for facilitating integration of assertions produced by different providers by forming the union of the two triple stores with the associated probabilities factoring into a calculation of the probability of the union. A knowledge graph with explicitly typed nodes and edges can also be particularly useful to facilitate non-trivial queries based on, for example, the SPARQL query language. For instance, a query could be “find all X's which are regulated by” or “find all signal transduction paths between A and B”.

What is claimed is:

1. A method for generating a knowledge graph from a corpus of literature wherein the corpus has multiple documents, comprising:
a. dividing documents from the corpus into sentences;
b. parsing each sentence into entries wherein an entry comprises (i) a pair of terms and (ii) a linguistic dependency path describing a directional relation between the terms;
c. creating a path-counts matrix from the parsed sentence entries comprising rows and columns wherein a row represents a pair of terms, a column represents a linguistic dependency path, and a cell represents the number of times in the corpus that the terms are connected by the path in a sentence;
d. creating a knowledge graph comprising a plurality of statements, wherein each statement is obtained from a portion of the corpus, each statement comprising at least four elements wherein two elements are terms, one element is a directional relation that connects the two terms to form an assertion, and one element is an estimated probability that the assertion is true or false, wherein at least two statements share one term in common and one term not in common and at least one statement comprises an assertion that is not a hypernym/hyponym assertion;
wherein the knowledge graph is created by:
i. creating a training data set by assigning to a subset of term pairs probabilities of the truth of a directional relation for the pair;
ii. using entries in the path-counts matrix and the training data set to produce rules for determining the probability related to the truth of a relation; and
iii. assigning probabilities of the truth of the relation for pairs of terms of the knowledge graph using the rules, thereby creating the knowledge graph; and
e. storing the knowledge graph on a computer readable medium.

2. The method of claim 1 further comprising the step of creating a link from the knowledge graph to at least one sentence from which the probabilities were derived.

3. The method of claim 1, wherein the training data set is modifiable by a user.

4. A knowledge graph on a computer readable medium derived from a corpus of literature comprising a plurality of statements, wherein each statement is derived from a portion of the corpus, each statement comprising at least four elements wherein;
a. two elements are terms;
b. one element is a directional relation that connects the two terms to form an assertion; and
c. one element is an estimated probability that the assertion is true or false;
wherein at least two statements share one term in common and one term not in common and at least one statement comprises an assertion that is not a hypernym/hyponym assertion.

5. The graph of claim 4, wherein the assertion contains an ontological relationship.

6. The graph of claim 4, wherein each statement comprises at least five elements wherein one element is a back-trace object that provides a link to the portion of the corpus that supports the veracity of the assertion.

7. The graph of claim 4, wherein the probability element of some statements is automatically generated from a corpus of data.

8. The graph of claim 4, wherein the probability element of most assertions in the graph is automatically generated from a corpus of data.

9. The graph of claim 4, wherein the graph is a resource description framework.

10. The graph of claim 9, wherein the framework is a probabilistic RDF.

11. The graph of claim 4, wherein the probability element is derived from a path-counts matrix from the corpus of literature wherein a column represents a linguistic dependency path, a row represents a pair of terms, and an entry represents the number of times the pair of terms is connected by the path in a sentence.

12. The graph of claim 11, wherein the path-counts matrix is from parsed sentences of the corpus of literature.

13. The graph of claim 11, wherein the entry of the path-counts matrix represents a boolean vector of the number.

14. The graph of claim 13, wherein the probability is calculated from the boolean vector by logistic regression.

15. A method of searching a corpus of literature comprising obtaining the link from the back-trace object of the graph of claim 6.

16. The method of claim 15 further comprising displaying the portion of the corpus from which the assertion was obtained.

17. The graph of claim 5, wherein the ontological relationship is part of an ontology.

18. An automatically produced structural digital abstract of a document comprising a machine readable abstract comprising a plurality of statements wherein a statement comprises at least four elements wherein;
a. two elements are terms;
b. one element is a directional relation that connects the two terms to form an assertion; and
c. one element is an estimated probability that the assertion is true or false;

19. The structured digital abstract of claim 18 wherein the probability element is generated by applying rules determined using a path-counts matrix produced from parsed sentence entries from a corpus of literature, wherein a column in the path-counts matrix represents a linguistic dependency path, a row represents a pair of terms, and an entry represents the number of times in the corpus the terms are connected by the path in a sentence.

20. The structured digital abstract of claim 18 wherein the assertions further comprise a link to the portion of the corpus from which the assertion was derived.

21. A method of semantically searching biomedical literature comprising:
a. providing a search string, wherein the string is at least one of a term a relation, and an assertion of two terms with a directional relation linking the terms;
b. comparing the search string with a knowledge graph produced from a corpus of literature which is. stored on a computer readable medium comprising a plurality of statements, wherein each statement is obtained from sentences within the corpus, each statement comprising at least four elements wherein;
i. two elements are terms;
ii. one element is a directional relation that connects the two terms to form an assertion; one element is an estimated probability that the assertion is true or false; and
iii. one element is a back-trace object that provides a link to the portion of the corpus from which the assertion was obtained;
c. ranking the statements obtained from the back-trace object that are most closely related to the search assertion; and
d. displaying a representation of a subset of the statements that are closely related to the search assertion.

22. The method of claim 21 further comprising displaying a sentence from the corpus from which the statement was obtained using the back-trace object.

23. The method of claim 21 further comprising displaying a reference from the corpus from which the statement was obtained using the back-trace object.

24. The method of claim 21 further the ranking is determined by at least one of the criteria selected from the group consisting of: the extent to which the statements match the search assertion, the impact factor of the reference from which the statements were derived, the number of citations to the papers from which the statements were derived, the number of citations to the authors of each paper, the number of citations involving topics which the paper covers, the time at which these papers were published, and the extent to which a given statement is central to a given topic.

25. The method of claim 21 further the knowledge graph is a structured digital abstract.

26. The method of claim 21 further the knowledge graph is a resource description framework.

27. The method of claim 26, wherein the framework is a probabilistic RDF.

28. The method of claim 21 further the portion of a sentence from which the statement was obtained is highlighted.

29. The method of claim 21 further entering search terms comprises issuing SQL or SPARQL queries.

30. A computer implemented method of searching the internet comprising:
a. methodically searching documents on web pages;
b. extracting the content of the pages with a program that utilizes a path-counts matrix, pairs of terms, and corresponding relationship probabilities derived from a corpus of literature to extract pairs of terms and calculate probabilities for relations between the terms; and
c. storing the extracted content of the pages in a computer readable format.

31. A computer program product that generates a knowledge graph comprising:
a. code that divides documents from the corpus into sentences;
b. code that parses each sentence into entries wherein an entry comprises (i) a pair of terms and (ii) a linguistic dependency path describing a directional relation between the terms;
c. code that creates a path-counts matrix from the parsed sentence entries comprising rows and columns wherein a row represents a pair of terms, a column represents a linguistic dependency path, and a cell represents the number of times in the corpus that the terms are connected by the path in a sentence;
d. code that creates a knowledge graph comprising a plurality of statements, wherein each statement is obtained from a portion of the corpus, each statement comprising at least four elements wherein two elements are terms, one element is a directional relation that connects the two terms to form an assertion, and one element is an estimated probability that the assertion is true or false, wherein the knowledge graph is created by:
i. creating a training data set by assigning to a subset of term pairs probabilities of the truth of a directional relation for the pair;
ii. using entries in the path-counts matrix and the training data set to produce rules for determining the probability related to the truth of a relation; and
iii. assigning probabilities of the truth of the relation for pairs of terms of the knowledge graph using the rules, thereby creating the knowledge graph.

32. A computer program product that generates a structured digital abstract comprising:
a. code that divides a document into sentences, wherein the document belongs to or is to be added to a corpus of literature;
b. code that parses each sentence into entries wherein an entry comprises (i) a pair of terms and (ii) a linguistic dependency path describing a directional relation between the terms;
c. code that creates a path-counts matrix from the parsed sentence entries comprising rows and columns wherein a row represents a pair of terms, a column represents a linguistic dependency path, and a cell represents the number of times in the corpus that the terms are connected by the path in a sentence; and
d. code that creates a knowledge graph comprising a plurality of statements, wherein each statement is obtained from a portion of the corpus, each statement comprising at least four elements wherein two elements are terms, one element is a directional relation that connects the two terms to form an assertion, and one element is an estimated probability that the assertion is true or false, wherein the knowledge graph is related to the document, thereby creating a structured digital abstract.

33. A business method comprising;
a. entering into a contract with an owner of a corpus of literature to produce an ontological graph from their corpus;
b. producing a knowledge graph by creating a path-counts matrix from the parsed sentence entries from the corpus of literature wherein a column represents an linguistic dependency path, the rows represent a pair of terms, and the entries represent the number of times the terms are connected by the path in a sentence, wherein revenue is derived from the use of the knowledge graph that was generated from the owner's corpus of literature.

34. The business method of claim 33 wherein the revenue is derived by selling ad space on a web page that allows search of the knowledge graph.

35. The business method of claim 33 wherein the revenue is derived by selling access to the database.

36. A graph representing assertions derived from a body of literature, wherein the assertions are represented in statements, wherein each of the statements includes two terms and relation, the relation term connecting the two terms, thereby fomming an assertion, the graph comprising:
a. a plurality of assertions, each representing the two terms and a relation, wherein the relation is a directional relation; and
b. at least one estimated probability that the directional relation of at least one of the assertions is true or false.

37. A method for determining a confidence level of an assertion present in a body of literature wherein the assertion represents a relationship between two terms, the method comprising:
a. generating relational data to represent a relationship between each of the terms and the assertion; and
b. using the relational data to estimate a confidence level for the assertion.

38. The method of claim 37 wherein the relational data is represented in a path-counts matrix.

39. A method for determining a veracity level of an assertion representing a relationship between two terms using a body of literature, the method comprising:
a. from the body of literature, automatically accessing assertions where each assertion represents an relation that connects the two terms;
b. for the automatically accessed statements, defining a numerically-based relationship with the assertion;
c. using the numerically-based relationship to generate estimated probability data as a confidence level for the assertion.

40. A computer implemented method comprising:
a. generating relational data from a corpus of literature for a pair of terms in a corpus of literature; and
b. correlating the relational data with a confidence level for an assertion, wherein the assertion comprises the terms and a directional relation that connects the terms.

41. The method of claim 40 further comprising displaying the confidence level and the assertion on a user interface.

42. The method of claim 40 further comprising providing the confidence level and assertion to a user conducting a computer based search.

43. A method comprising:
a. executing computer code that generates training data comprising a plurality of elements, each element comprising (i) an assertion comprising a pair of terms from a corpus and a directional relation between the terms, (ii) a confidence level that the assertion is true or false for the terms and (iii) relational data between the terms derived from the corpus; and
b. executing computer code that generates a rule that classifies the confidence that the assertion is true or false for a pair of terms from the corpus.

44. A system comprising:
a. a database comprising a corpus of literature in machine readable form; and
b. a computer comprising an algorithm for determining a confidence level of an assertion present in a body of literature wherein the assertion represents a relationship between two terms, wherein the algorithm; (i) generates relational data to represent a relationship between each of the terms and the assertion; and (ii) uses the relational data to estimate a confidence level for the assertion.
